(19) United States
(12) Patent Application Publication
(10) Pub. No.: US 2009/0327023 A1
(43) Pub. Date: Dec. 31, 2009

(54) SYSTEM FOR MANAGEMENT AND CONTROL OF AN ENTERPRISE

(76) Inventor: Chris NANJI, Palos Verdes Estates, CA (US)

Correspondence Address: FITZPATRICK CELLA HARPER & SCINTO, 1290 Avenue of the Americas, NEW YORK, NY, 10104-3800, US

(21) Appl. No.: 12/492,046

(22) Filed: Jun. 25, 2009

Related U.S. Application Data
(60) Provisional application No. 61/075,629, filed on Jun. 25, 2008.

(51) Int. Cl. G06Q 10/00; G06Q 50/00; G06F 17/00

(52) U.S. Cl. 705/9; 705/7; 705/8; 705/11; 715/234

(57) ABSTRACT

A system for management of an enterprise, including a quality system module provided for storing quality parameters derived from at least one quality system certification standard, and an interface operable by a user for retrieving data based on at least one of the quality parameters in response to a request from the user. Another system includes an operating procedure module storing detailed procedures for carrying out at least one task, and an interface operable by a user for retrieving data related to the detailed procedures.

This application claims the benefit of U.S. Provisional Application No. 61/075,629, which is hereby incorporated by reference.

### BACKGROUND OF THE INVENTION

1. Field of the Invention

Example aspects of the invention relate generally to managing an enterprise, and, more particularly, to using modules to control various processes, tasks, procedures, equipment, materials, etc., associated with the management and control of an enterprise.

2. Description of the Related Art

Managing and controlling an enterprise can be a costly and time-consuming venture. To reduce the cost and time expenditures, various systems and methods for enterprise management and control have been proposed or constructed, yet these still have shortcomings. Many of these systems fail to provide unified solutions for comprehensive management of an enterprise, and instead simply provide systems geared toward specific, narrow areas. Oftentimes, these systems are “information silos”, meaning they are disjointed from each other, and lack cross-correlation and inter-communication. Prior systems also are often personnel-intensive, in that their operation requires significant expertise on the part of many employees. Moreover, even with these systems deployed by enterprise, the management and control of the enterprise can remain prone to human error.

Compounding the above drawbacks to prior systems is that it can be particularly important for an enterprise to establish a quality system and quality procedures, which can be necessary to achieving or maintaining a quality system certification (QSC) of a quality management system (QMS) standard, such as ISO9001, AS9100B, and others. The process by which an enterprise prepares for certification under a QMS standard can be complex and expensive, including conducting internal audits and adhering to a quality policy manual (QPM), quality system procedures (QSP), and standard operating procedures (SOP). Prior systems generally fail to assist an enterprise in this process. Without such assistance, it can be difficult and costly for the enterprise to receive a QSC. Even if the enterprise dedicates personnel and resources to the certification process, a QSC still can be difficult to obtain, requiring the enterprise to produce documents and other information (which often are scattered over multiple locations) and pass multiple audits (which can require showings of traceability in the enterprise's business and demonstrations of the adequacy of procedures).

In addition to (or as part of) establishing a working quality system, enterprises often wish to standardize their operating procedures, in order to enable the enterprise to operate in an efficient, cost-effective manner. However, such an undertaking can be a complex process requiring the standardization of many procedures, which may be utilized by many departments or divisions. As a result, an enterprise may not complete the standardization process or may not regularly update their procedures. Therefore, many enterprises may have operating procedures that are inadequate, outdated, or undocumented, and such procedures may not be readily available to all personnel. Prior systems for enterprise management often lack capabilities for assisting an enterprise in establishing (and carrying out) standard operating procedures in an organized, cost-effective manner.

### SUMMARY OF THE INVENTION

Systems for managing an enterprise are provided. According to an example aspect of the invention, a system includes a quality system module (and/or another regulatory certification module), provided for storing quality parameters derived from at least one quality system certification standard, and an interface operable by a user for retrieving data based on at least one of the quality parameters in response to a request from the user.

According to another example aspect of the invention, a system includes an operating procedure module storing detailed procedures for carrying out at least one task, and an interface operable by a user for retrieving data related to the detailed procedures.

According to still another example aspect of the invention, a system includes a quality system module provided for storing quality parameters derived from at least one quality system certification standard; an operating procedure module storing detailed procedures for carrying out at least one task; and an interface operable by a user for retrieving data based on at least one of the quality parameters and retrieving data related to the detailed procedures in response to a request from the user.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings.

FIG. 1 is a diagram of a system according to an example embodiment of the invention.

FIGS. 2 through 43 illustrate display windows of routines according to various example embodiments of the invention.

FIG. 44 is an example data processing architecture.

FIG. 45 illustrates a display window of a routine according to an example aspect of the invention.

### DETAILED DESCRIPTION OF THE PREFERRED EMBODIMENTS

As used herein, “enterprise” can refer to any business, company, firm, or comparable organization including sole proprietorships, partnerships, corporations, and cooperatives. An enterprise may engage or operate in one or more industrial sectors, including, for example: manufacturing; research; construction; information; wholesale trade; retail trade; finance and insurance; management of companies and enterprises; real estate, rental, and leasing; mining; utilities; transportation and warehousing; agriculture, forestry, fishing, and hunting; professional, scientific, and technical services; administrative, support, waste management, and remediation services; educational services; household services; health care and social assistance; arts, entertainment, and recreation; accommodation and food services; public administration; and other service industries. An enterprise can be for-profit or non-profit.

References herein to “members,” or similarly-worded phrases such as “members of an enterprise,” refer to individuals (e.g., employees) and entities (e.g., third-party contractors) associated with an enterprise. Also, references herein to “managers,” or similarly-worded phrases such as “managers of an enterprise,” refer to individuals and entities having managerial or supervisory roles within an enterprise. Furthermore, managers also should be understood to be members of an enterprise, i.e., such roles in an enterprise are not mutually exclusive. Moreover, the foregoing terms should be interpreted in their broadest sense and in accordance with the understanding of those having skill in the relevant arts.

### I. Example Systems for Managing and Controlling Enterprises

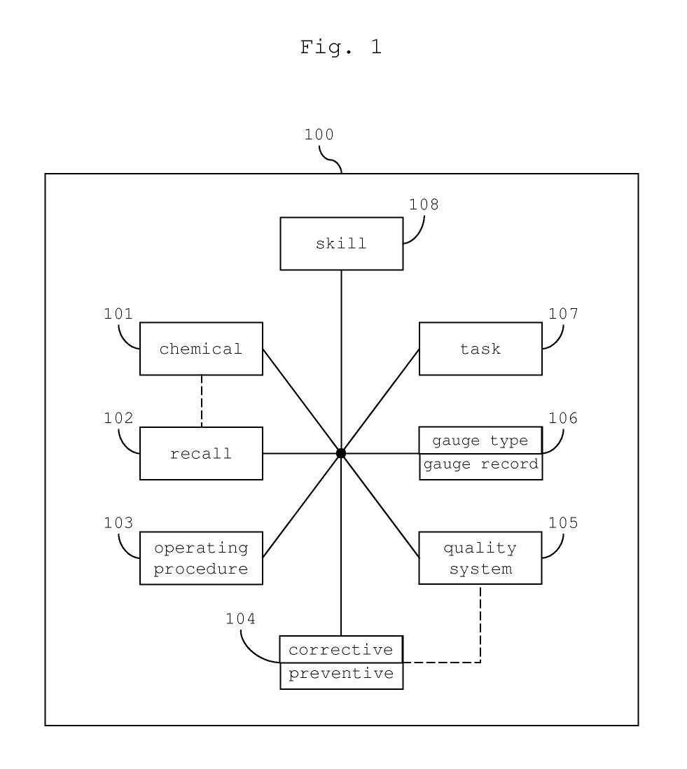

By virtue of example aspects of the invention, management, control, and/or certification of an enterprise can be effected through the use or performance of a suite (or system) of one or more modules. An example aspect of the invention is that the modules can be integrated to provide the enterprise with a quality management system (QMS). FIG. 1 shows a diagram of an example suite 100 configured in accordance with this aspect (as well as other aspects) of the invention. Through the use of the suite (and its component modules), an enterprise can achieve and maintain a quality system certification (QSC). According to an example embodiment of the invention, these certifications include ISO 9001:2000, AS9100B, and AS9110, although the invention is not limited to these specific examples. By achieving (and maintaining) a quality system certification, an enterprise can assure the quality of its operation and output (e.g., products, services, etc.) to third parties (e.g., customers, vendors, consumers, etc.). Such quality assurance may be necessary for the enterprise to become or remain competitive in an industry in which the enterprise operates. For example, original equipment manufacturers (OEMs) in certain industries (e.g., aerospace and medical) may require that their contract manufacturers (CM) and/or original design manufacturers (ODM) adhere to one or more specific QSCs.

Through use of the suite 100, an enterprise can achieve a QSC. A module (or modules) in the suite can facilitate the certification process, and also decrease the time and cost associated with achieving and maintaining the certification. The module can provide, for example, a framework for establishing a quality system (as well as accompanying documentation and procedures) needed for certification. The module also can prompt for, receive, and/or process data provided by the enterprise, allowing for the quality system to be configured specifically for the enterprise. As a result, a unique, electronic, auditable, revision-controlled quality system can be created easily through the use of suite 100, with the quality system also configurable to be cross-correlated with other modules in the suite.

The suite can be used to further improve the organizational efficiency of the enterprise by providing effective management tools. Members of the enterprise can access information such as, for example: which members are assigned to which tasks; which processes required for a particular task have been completed, and which processes remain uncompleted; which tasks have been suspended pending a managerial decision; which equipment requires preventive maintenance; and which materials require renewal or replenishment. By virtue of such informational accessibility, the enterprise's management can confidently delegate and monitor tasks, as well as review any quality and compliance tasks (e.g., tasks critical to achieving and/or maintaining a QSC). Moreover, the suite can perform computations in real time or at predetermined intervals. The computations can be cross-correlated among modules to provide the enterprise with comprehensive reports, alerts, and other notifications of tasks, processes, etc., which require attention.

The suite further can be used to improve the organizational efficiency of the enterprise by enabling accountability at the individual and management levels. By virtue of the task management tools described above, management members can view individual members' progress on assigned tasks, allowing for management to identify process (and task) bottlenecks, delayed tasks, and any other unproductive activity. Managerial activity also can be viewed, allowing the various levels of management to supervise and/or identify similar unproductive activity at subordinate levels. Thus, enterprise workflow, including assigned tasks and their associated processes, can be escalated through management levels, ensuring that quality and compliance requirements are met.

The suite still further can improve the operational efficiency of the enterprise by providing a collaborative work environment, which can be driven by real-time operational information. Operational information can be generated by one or more of the component modules comprising the suite, or can be entered, selected, or otherwise stored in one or more modules by a member of the enterprise. Operational information can be entered, for example, manually or by scanned bar code. Such operational information can be used to automatically populate or otherwise provide data to modules of the suite. Operational information also can be used to track or adjust enterprise processes, while simultaneously creating or updating auditable records. Operation information further can be used to, for example, model processes performed by the enterprise, and also to create seamless process flows within and between various departments of the enterprise. Moreover, time- and event-based triggers (e.g., alarms, email reminders, etc.) for due and review dates can be configured and activated through the suite.

The suite 100 and any of its associated modules can be customized to the needs of particular enterprise. For example, an enterprise's managerial and departmental structures can be implemented into the modules of suite 100. When customized in this manner, an enterprise can operate the suite to efficiently assign and delegate tasks between departments and/or levels of management. As another example, an enterprise can customize the suite and its modules to contain and/or display enterprise-specific data and images (e.g., a corporate logo) and use enterprise-specific terminology.

According to an example embodiment of the invention, the suite 100 can be configured as a network-based system (e.g., a system hosted on one or more dedicated servers, which can be accessed from one or more remote terminals). When configured in this manner, a third party can provide (and/or operate) any servers, networks, and/or terminals required for an enterprise to access the modules (as well as perform any associated routines and receive any functions or results generated by the modules). The third party's provisioning of access to the suite and modules may be provided for a fee (e.g., a subscription fee, a one-time access charge, etc.) or other compensation. The enterprise then can access the modules through remote operation via the terminals. As a result, an enterprise's information technology (IT) investment in the suite can be reduced or minimized while still maintaining the complete functionality of the suite. This result can be particularly advantageous for smaller enterprises or those that require reduced operating costs. Moreover, a network-based configuration can improve the availability of the suite 100 to the enterprise and its members, and also can enable regular data backup, data archiving, restricted and/or secure access, etc. For example, an enterprise's management can configure the suite such that a member of the enterprise can access any of the modules from any suitable computer via an Internet connection. In this example, the management can configure or otherwise provide for the member's connection and/or access to be secure, allowing the enterprise (and management) to retain complete control over the information contained therein.

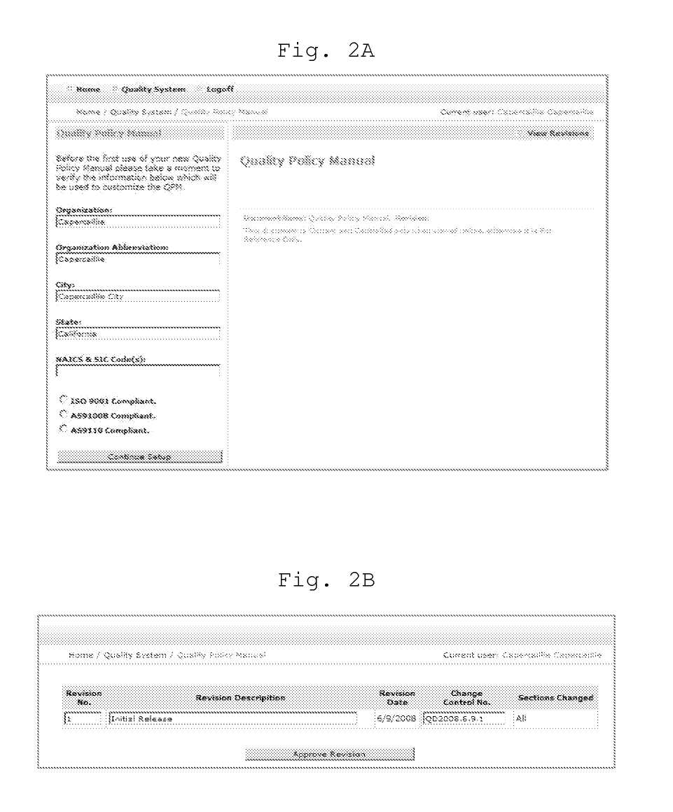

As described above, the suite illustrated in FIG. 1 is an integrated suite of modules. These modules include a chemical module 101, a recall module 102, an operating procedure module 103, a corrective module 104 (including corrective action and preventive action sub-modules), a quality system module 105, a calibration module 106 (including gauge type and gauge record sub-modules), a task module 107, and a skill module 108. Examples of the modules 101-108 (and associated sub-modules) illustrated in FIG. 1 are discussed in detail below in connection with FIGS. 2 through 43. The modules of FIG. 1 can be interlinked or correlated in various ways, as illustrated by the solid line interconnecting the modules. For example, changes made in one module can result in changes to another module, and a function, routine, or other action taken by one module can cause another module to perform another function, routine, or other action. Modules can have increased interlinking or correlation to other particular modules, as is illustrated by the dashed lines between modules 101 and 102 and between modules 104 and 105. Over the course of using suite 100, such as through the population of data into (and by) various modules, the levels of interlinking and correlation between modules can increase. Of course, suite 100 is simply an illustration of an example suite according to one aspect of the invention. Other systems may be configured and can include one or more of the modules shown in FIG. 1, and/or other modules not shown in FIG. 1.

According to an example aspect of the invention, a system, such as suite 100, can be accessed via an interface allowing for navigation to, access of, and control of each module. The interface of suite 100 can include an overview or display of one or more modules, such as, for example, the statuses, pending items, past due items, etc., associated with one or more modules. In this manner, control of suite 100 can be on a global level, as well as through control of individual modules. In an example embodiment where the suite is configured as a network-based system, the suite can include a configurable web interface, through which any of the functions, features, routines, etc., of the suite (and modules) described herein can be configured.

In various example embodiments of the invention, a module, including any of those shown in FIG. 1, can be hardware (e.g., personal computers, servers, and integrated circuits), software (e.g., enterprise software, enterprise infrastructure software, application software), or any combination thereof. According to an example embodiment of the invention, the individual modules comprising suite 100, which may be configurable in accordance with example aspects of the invention, can be web-based applications designed using software such as Microsoft SQL Server 2000, Microsoft SQL Server 2005, Windows 2000 Server, Windows 2003 server, Windows 2008 server, or any other suitable software. In this example embodiment, the modules can include, for example, COM objects (e.g., COM+ objects), stored procedures, active server pages (ASP), and/or ASP.NET pages. These modules may then be integrated via a network-based framework, through which multiple modules may be configured, activated, and/or controlled.

In various example aspects of the invention, a system (such as suite 100) can be used to manage and control an enterprise in various ways. These example aspects include achieving a QSC, operating an enterprise, and performing diagnostics. Example modules, which may be suitable for practicing the above example aspects of the invention, will now be described. The modules are described with reference to particular aspects. However, the modules are described in this manner simply to highlight one or more features or functions associated with the modules. In practice, these modules are sufficiently flexible and configurable so as to be useful in ways other than those described below, as will be recognized by those having skill in the relevant arts.

### II. Achieving a QSC

It can be particularly important for an enterprise to establish a quality system and quality procedures, and achieve or maintain a QSC. An enterprise may require a QSC to meet a contractual or regulatory requirement. An enterprise also may wish to have a QSC because of customer or consumer preferences, or simply to develop its management system. Moreover, as described above, a QSC can be necessary or important for an enterprise to generate revenue or to profitably operate; this may be the case in, for example, the aerospace and medical industries. Therefore, an enterprise may seek to obtain a QSC for any number of reasons.

Achievement of a QSC can require independent verification of an enterprise's conformance to a QMS standard. An example of a process for achieving a QSC is as follows. The enterprise must be externally audited by a third party certification body (CB), which may be recognized by an accrediting body (such as the ANSI-ASQ National Accreditation Board). The CB conducts the audit by examining the functioning of the enterprise, as well as its processes, products, and services, for conformance to the requirements of the relevant standard. If the audit does not reveal any major non-conformances and all requirements are met, the CB can issue a QSC certificate for the enterprise.

The process by which an enterprise prepares for (and passes) a CB audit for a QMS standard can be complex and expensive. Preparation for an audit may include, for example: conducting (and maintaining records of) internal audits; preparing and adhering to a quality policy manual (QPM) or similar quality manual; preparing and carrying out quality system procedures (QSPs) or other documented procedures; preparing and carrying out standard operating procedures (SOPs); and preparing and using standard and/or customized forms. Those having skill in the relevant arts will recognize that, with regards to specific QMS standards (in particular, ISO9001:2000 and AS9100), a QPM can comprise Level 1 documentation, QSPs can comprise Level 2 documentation, SOPs can comprise Level 3 documentation, and forms (standard and customized) can comprise Level 4 documentation.

An additional hurdle for an enterprise faced with the challenge of achieving a QSC is that auditing and certification may come during a difficult time for the enterprise, such as, for example, during the initial startup of the enterprise or after the enterprise has been denied a QSC by a CB. Therefore, it can be particularly advantageous for an enterprise to achieve a QSC with as little expense and difficulty as possible. Achieving a QSC in such a manner can be accomplished through the use of, for example, a quality system module and/or a standard operating procedure module.

A. Quality System Module

According to an example embodiment of the invention, a quality system module can be configured to create, edit, and maintain both Level 1 and Level 2 documentation, i.e., a QPM and QSPs. According to this example embodiment of the invention, the quality system module can have two sub-modules: a QPM module and QSP module, both of which are described below. The establishment and maintenance of a QPM and QSPs may be required when operating an enterprise in accordance with one or more published QMS standards (e.g., ISO9001, AS9100B, and AS9110). Moreover, certain sections or content of a QPM and QSPs may be specifically set forth or required by a QMS standard. Therefore, the quality system module can assist an enterprise in operating according to such a published standard, and, ultimately, in achieving a QSC for that standard.

The operation of a quality system module can include selecting a published QMS standard. Once a standard has been selected, a QPM and QSPs can be created. The QPM and QSPs can be web-based documents stored in an appropriate online format. Each document can include hypertext links, which can allow for navigation between document sections, among other documents, and to other modules in the system according to the present invention. From the quality system module, each document also can be output in a format suitable for printing (e.g., PDF, Microsoft Word, etc.), such that printed copies of the QPM and QSPs, in whole or in part, can be made readily available to members of the enterprise. A QPM created by an enterprise through the quality system module can be, in whole or in part, pre-written or pre-formatted content, and also can include content created by the enterprise or a third party. Similarly, QSPs created by the enterprise can consist of, in whole or in part, pre-written or pre-established content, or can be content created or established by the enterprise or a third party.

According to an example embodiment of the invention, an initial (or first) version of a QPM can be provided to the enterprise as part of the quality module, i.e., a complete (or nearly complete), pre-written QPM can be included with the module. Normally, an enterprise must spend a large amount of time and money establishing its own QPM. In fact, some enterprises resort to hiring (at a significant expense) third parties to write their QPMs. However, by using the QPM provided by the quality module and tailoring the QPM through the module's functions and routines, an enterprise can quickly establish a complete, satisfactory QPM, thereby saving the time and cost normally associated with creating a QPM. An enterprise can tailor or otherwise customize a QPM through content population routines included with the module, some of which are described below. These routines can include prompts to add text, images, or other content. In this manner, an enterprise can be taken step-by-step through the creation of a QPM specific to the enterprise, including the creation and/or editing of sections of a QPM such as mission, quality policy and objectives, quality policy, quality objectives, business scope, and an organizational diagram.

Once created, the QPM and QSPs can be fully editable and controllable, though editing (and control) privileges may be restricted to certain members and/or managers. Changes to the QPM and QSPs can be recorded, such that later operators of the quality system module can identify prior operators and any changes they may have made. Furthermore, previous versions of a QPM and QSPs can be archived for later retrieval and for auditing purposes. Such recordation and archiving may assist in (or be required for) internal and external audits of the enterprise.

Information entered into, included with, and/or stored by an example quality module and, in particular, QPM and QSP sub-modules, may include: organization, location, classification, standard, revision, and change control information. Organization information can include a name of an enterprise for which a QPM (or QSP) is provided. Location information can include a street address, city, state, and/or country, at/in which an enterprise is located. Classification information can be one or more classifications of enterprise, and can include North American Industrial Classification System (NAICS) and Standard Industrial Classification (SIC) codes. Standard information can be one or more published standards (e.g., ISO 9001, AS9100B, AS9110) to which a QPM (or QSP) may adhere. Revision information can include a number (integer, serial, etc.), which can identify a particular version of a QPM (or QSP), a date, which can be a creation/revision date of a particular version of a QPM (or QSP), and descriptive text, which can provide information relevant to one or more particular versions. Change control information can include a unique identifier, author, revision date, approval code, or any other information allowing for changes to be introduced to a quality module in a controlled and coordinated manner. Change control information may be cross-correlated to information associated with another module, such as a skill module, as discussed below.

According to an example embodiment of the invention, a quality module and, in particular, a QPM sub-module can include routines for: creating first and additional revisions of a QPM; viewing and printing a QPM; and adding and editing content of a QPM. FIGS. 2A and 2B illustrate display windows of routines for creating a first revision of a QPM. In the routine of FIG. 2A, information, such as organization and location information, for initially accessing a QPM creation routine is entered and/or verified. This routine can be limited to performance only when an enterprise has not established a QPM. FIG. 2B illustrates a display window of a QPM creation routine, which can be accessed once the initial information has been entered and/or verified. According to an example embodiment of the invention, the first revision of a QPM can be provided as part of the quality module, i.e., a pre-written QPM can be provided. Thus, the routine of FIG. 2B may not require the entry of any content, but rather simply revision, i.e., version, information for the QPM.

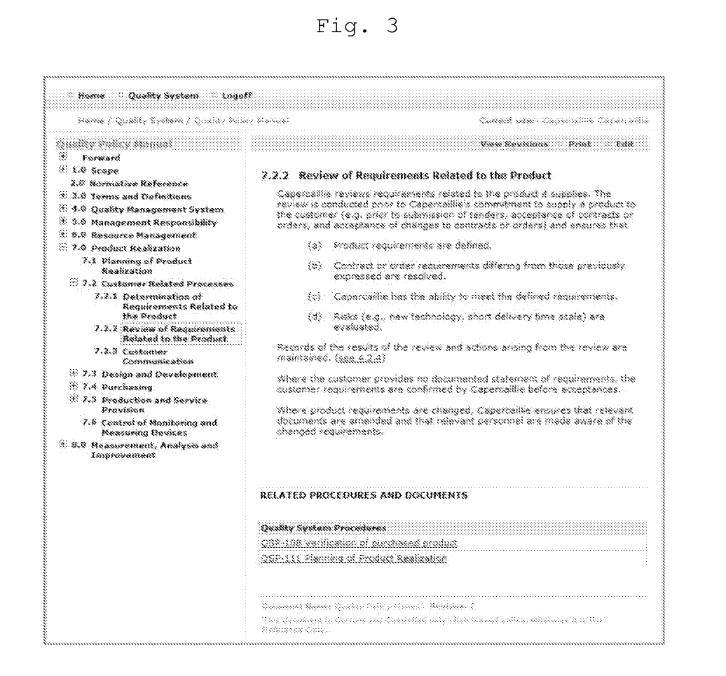

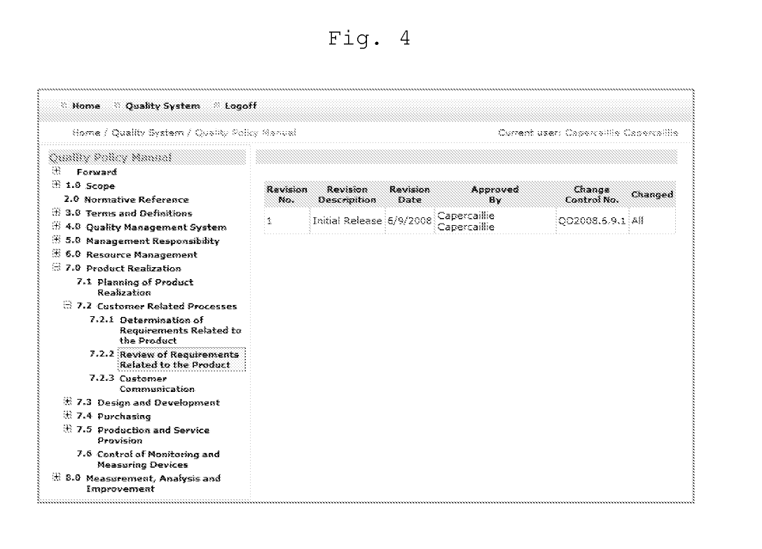

FIGS. 3 and 4 illustrate display windows for viewing various aspects of a QPM. In the routine of FIG. 3, the content of a QPM can be viewed by, for example, a member of the enterprise. The content can be sorted into various sections or subsections, headings, or in any other appropriate format. The routine also can include navigating the QPM. As shown in the illustration of FIG. 3, navigating the QPM can include a sub-window, popup, or frame containing a tree or similar hierarchical display for quickly viewing sections, headings, etc., of the QPM. The routine further can include content (or hyperlinks to content) related to the QPM content currently being viewed. This related content can be other sections of the QPM, or related QSPs and SOPs (or sections thereof), or any other related information included in other modules (such as those modules illustrated in FIG. 1). The routine of FIG. 3 also can include printing a QPM. Printing of a QPM, as performed by this routine, may be actual printing by a printer, or may simply be exporting in a printable format (e.g., PDF). In the routine of FIG. 4, the revision information for a particular QPM (or a section or sub-section thereof) can be viewed.

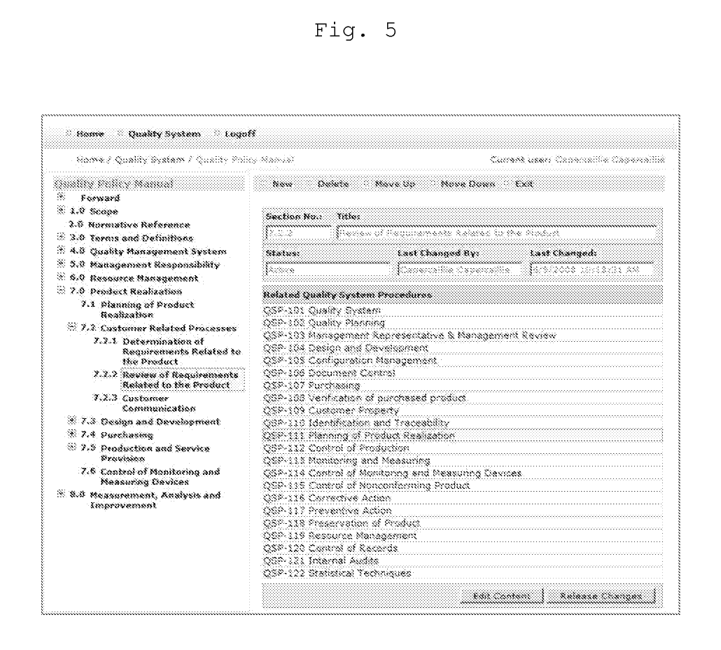

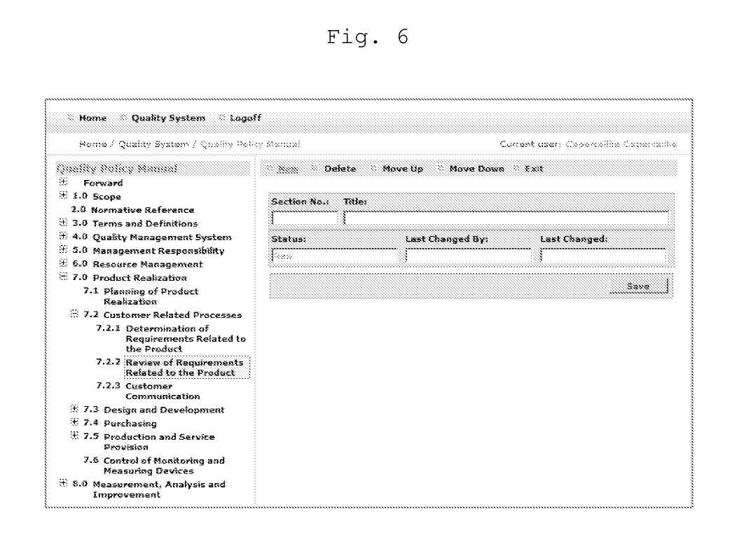

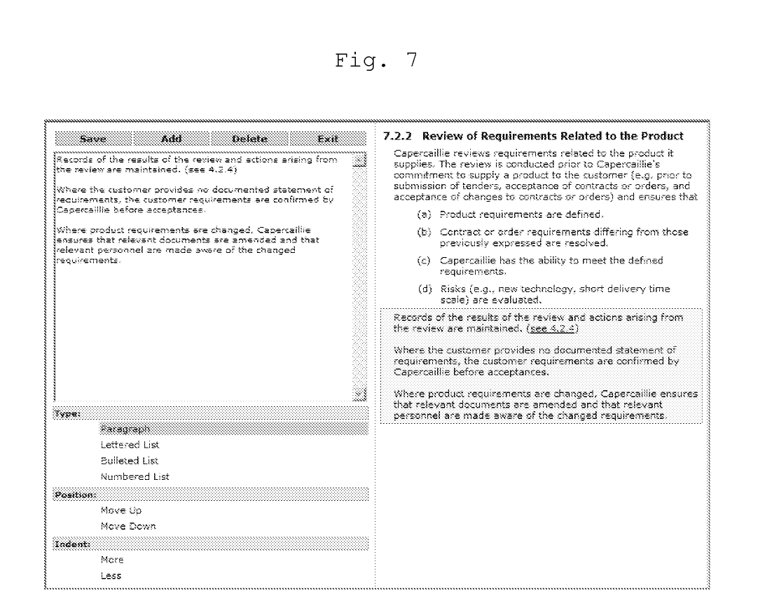

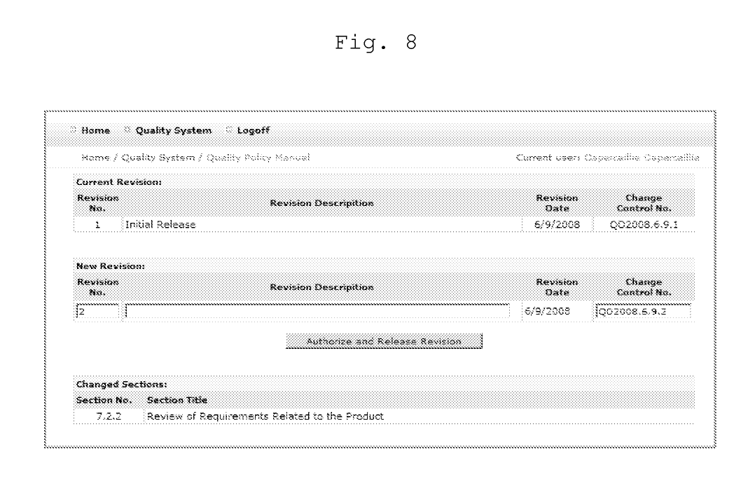

FIGS. 5 through 8 illustrate display windows of routines for revising a QPM, and adding and/or editing its associated content. In the routine of FIG. 5, information relating to a section (or sub-section) of a QPM can be edited and/or added. Such information can include section information, links to any related QSPs or SOPs, or links to any other related modules or content. In the routine of FIG. 6, a new section of an existing QPM can be created. Additionally, its sorted location can be changed relative to other sections of the QPM. In the routine of FIG. 7, content of a QPM can be added and/or edited. From the display window of this routine, a member can add new content (such as text, images, and movies), edit previously-entered content, or delete content. Also includable in this routine are controls for formatting content (e.g., text format controls such as indenting; paragraph format controls such as listing, bulleting, numbering; and procedure positioning controls for moving or rearranging one or more elements of a QPM section. In the routine of FIG. 8, new revisions of a QPM (or sections or sub-sections thereof) can be authorized and/or released.

According to an example embodiment of the invention, a quality module and, in particular, a QSP sub-module, also can include routines for: creating first and additional revisions of QSPs; viewing and printing QSPs; and adding and editing content of QSPs. These routines can be similar in form and function to the QPM routines described above in connection with FIGS. 2 through 8. However, certain differences and/or features of the QSP routines will now be described.

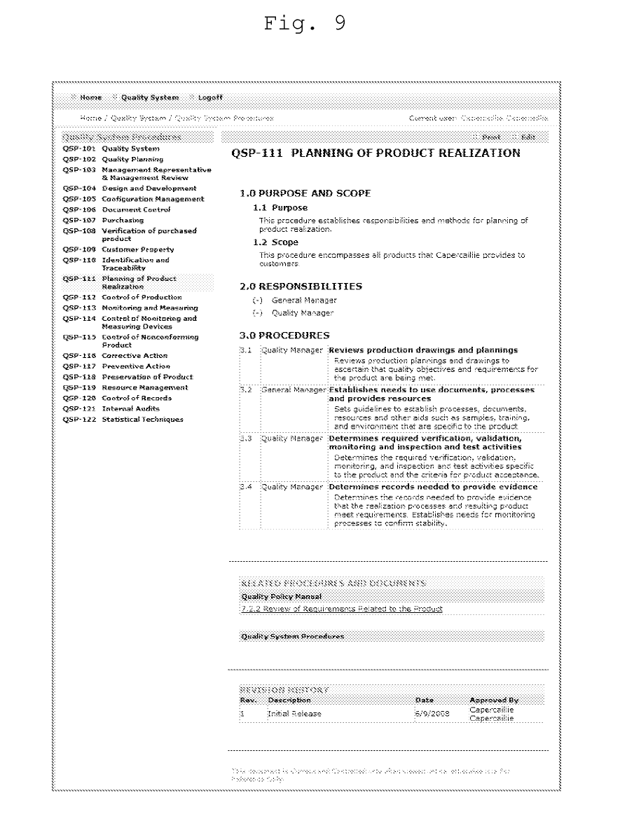

FIG. 9 illustrates a QSP viewing routine. QSPs can include procedures for: management control and review; document control; purchasing; verification of purchases; maintenance and/or management of property (both enterprise-owned and third party-owned); product planning; control of monitoring and measuring devices and equipment; control of nonconforming products; actions (e.g., preventive and corrective, which are both described below); product preservation; record control; resource management; internal auditing; and statistical techniques. Those having skill in the relevant arts will recognize that the QSPs set forth by an enterprise can vary from the preceding examples, and can relate to (or be specified by) any QMS standard. QSPs can be created (and their content added and/or edited) through routines similar to those described above for a QPM.

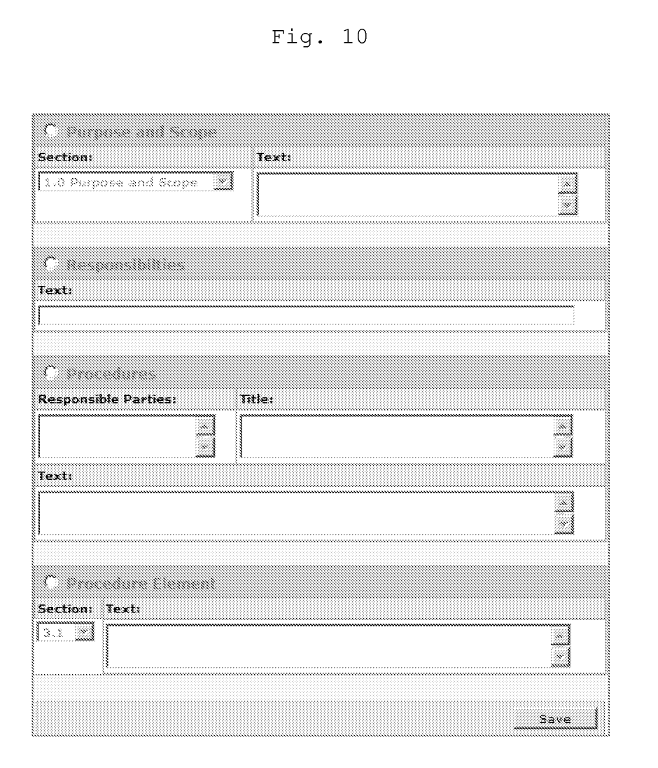

FIG. 10 illustrates a routine for adding an element to a QSP. An element can be any data structure, which comprises a QSP. An example data structure is a block (e.g., a paragraph) of text. By virtue of the routine of FIG. 10, a QSP can be formed from multiple elements, and each element can be properly formatted.

By virtue of the example features described above in connection with the quality system module (and the QPM and QSP sub-modules), quality policies and procedures, such as those associated with a QMS, can be set forth for implementation by an enterprise. Moreover, once established, the QPM and QSPs can be easily updated or completed to suit any changing needs of the enterprise or any changes required by ISO9001, AS9100, or the like. Further, such procedures can be created (and changed) from within the enterprise and without the need for third-party consultants. The quality system module also can ensure that a QPM and QSPs are uniform and/or standardized across the enterprise's departments or divisions. A QPM and QSPs also can readily accessible at all times to all members of the enterprise.

B. Operating Procedure Module

According to an example embodiment of the invention, an operating procedure module can be configured to create, edit, and maintain Level 3 documentation, i.e., the standard operating procedures (SOPs) of an enterprise. The establishment and maintenance of SOPs may be required when operating an enterprise in accordance with one or more published QMS standards (e.g., ISO9001, AS9100B, and AS9110). Therefore, the operating procedure module can assist an enterprise in operating according to such a published standard, and ultimately in achieving a QSC for that standard.

The operation of an operating procedure module can include creating SOPs that implement or otherwise adhere to an enterprise's QPM and QSPs. SOPs can be web-based documents that may include text, pictures, and movies, as well as hypertext links to other procedures and information stored on other modules. SOPs can be output from the operating procedure module as printed or electronic documents. SOPs created by an enterprise through the module can be, in whole or in part, pre-written or pre-formatted content, and also can include content created by the enterprise or a third party.

SOPs can be fully editable and controllable, though editing (and control) privileges may be restricted to certain members and/or managers. Changes to the SOPs can be recorded, such that later operators of the operating procedure module can identify prior operators, as well as any changes they may have made and when such changes were made. Furthermore, previous versions of SOPs can be archived for later retrieval and for auditing purposes. Such recordation and archiving may assist in (or be required for) internal and external audits of the enterprise.

Information entered into, included with, and/or stored by an example operating procedure module may include: QPM, QSP, trained member, trained member status, importance, complexity, weight, maximum points, purpose, scope, and procedure information. QPM and QSP information can be QPM sections (or subsections), QPM content, QSP titles, or QSP content related to a SOP. For example, a SOP implementing a particular QSP can crosslink, correlate, or contain information pertaining to that SOP. Trained member information can be the names and/or titles of members who have been or will be trained in a particular SOP, or members who can train other members. Trained member status can be a level to which a member has been trained in a particular SOP (e.g., “assigned for training”, “trained”, “able to teach”, etc.). Importance information can convey how important a SOP is to the management, control, and operations of an enterprise, and can include a numerical scale. Complexity information can convey the complexity involved in performing, training in, or teaching a SOP, and also can include a numerical scale. Weight information can be a combination of importance and complexity information; if these are numbers, weight can be a mathematical combination. Maximum points information can be a number of points which can be given to a member who has been trained in and/or can train others in a SOP. Member points will be discussed in detail below. Purpose information can include a description of the purpose for implementing or carrying out a SOP. Scope information can include a description of all applicable situations in which a SOP should be followed. Procedure information can include a description of all processes and procedures that must be followed to adequately complete a SOP.

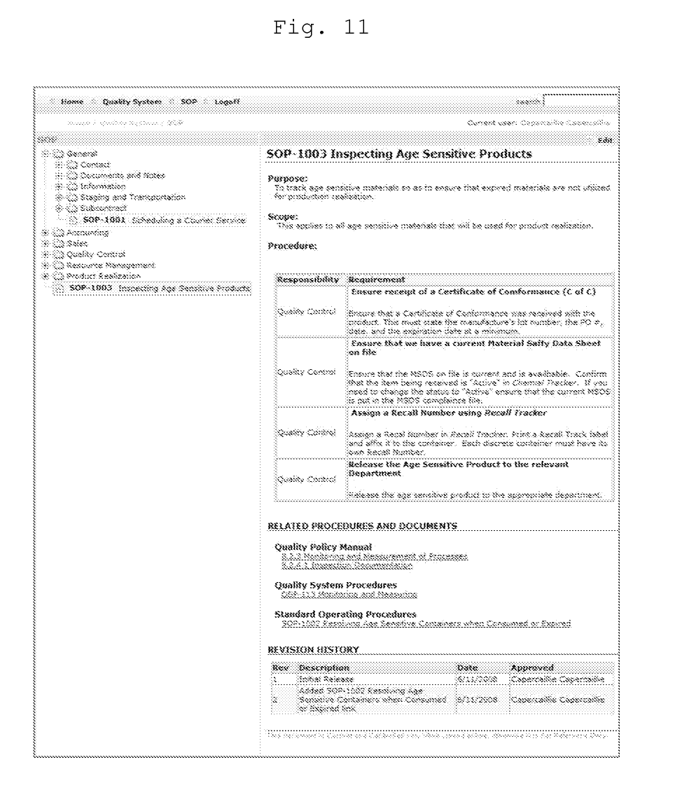

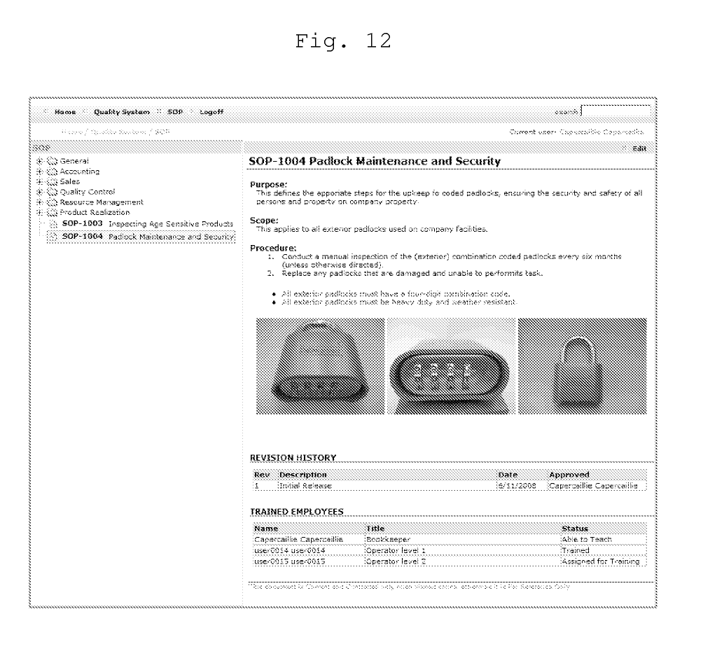

According to an example embodiment of the invention, an operating procedure module can include routines for creating and viewing SOPs, adding and editing content to SOPs, organizing SOPs, and searching for SOPs. FIG. 11 illustrates a display window of a routine for viewing SOPs. The display window can include various sections, such as: the SOP (i.e., purpose, scope, and procedure); any related SOPs, QPM sections, QSPs, or information from other modules; a revision history; and a hierarchical display of multiple (or all) SOPs. FIG. 12 illustrates another display window of a routine for viewing SOPs. This display window can include the SOP, hierarchical display, and revision history, as well as trained member and trained member status information.

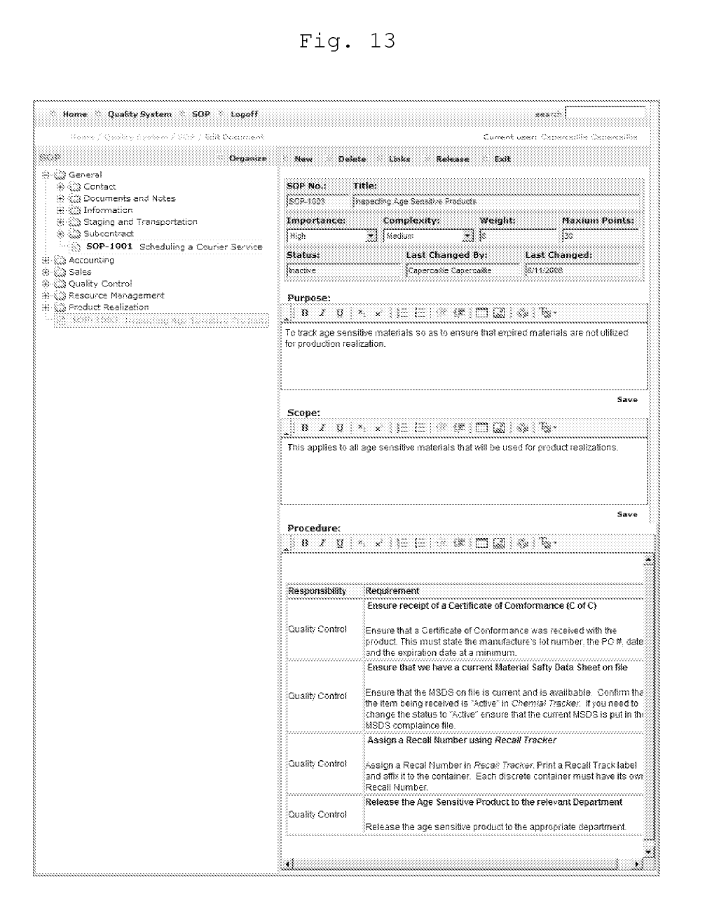

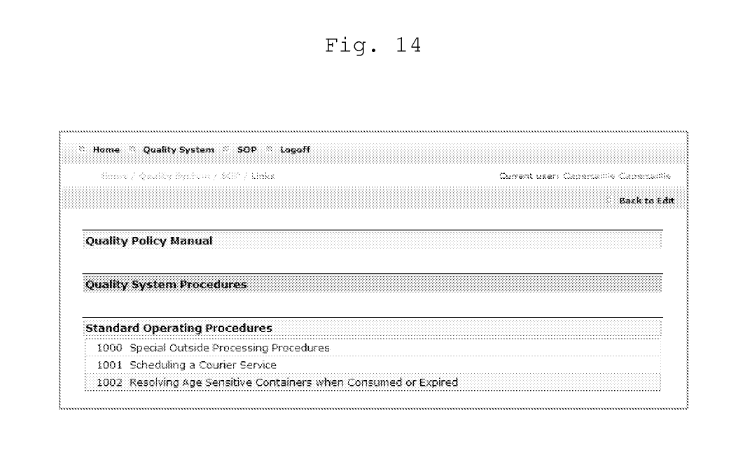

FIGS. 13 and 14 illustrate display windows of routines for editing SOPs. After a SOP has been added through a SOP adding routine (not shown), the routine of FIG. 13 can be performed, in which content and various information relating to the SOP can be added and/or edited. In the routine of FIG. 14, links from a particular SOP to related SOPs, QPM sections, and QSPs can be added or deleted. Moreover, an operating procedure module also can include other routines (not shown) for uploading and formatting data (e.g., pictures, movies, and other electronic files) for association with (or display in) an SOP. In this manner, a SOP can include not only a text description, but also, for example, a movie demonstrating the procedure or a picture(s) illustrating the procedure.

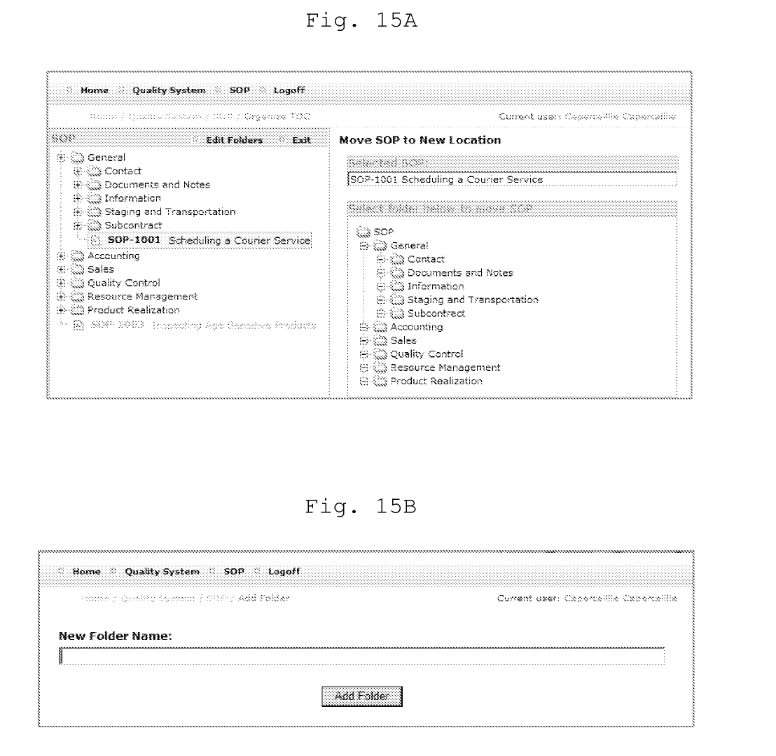

FIGS. 15A and 15B illustrate display windows of routines for organizing SOPs. In the routine of FIG. 15A, the various SOPs created and maintained by an enterprise can be filed in a filing system, such as a hierarchical system of folders. In the filing system, SOPs can be moved among folders, folders can be moved into (or out of) sub-folders, and, as shown in FIG. 15B, new folders can be created. The operating module also can include routines (not shown) for authorizing and releasing changes (or revisions) to SOPs. These routines can be similar to those discussed above for a QPM and QSPs.

By virtue of the example features and routines described above in connection with the operating procedure module, SOPs for an enterprise can be established and implemented. The SOPs can be readily available to all members of the enterprise, and members can be assisted in carrying out a SOP by text, images, audio, etc., which can be easily entered, formatted, and/or uploaded for association with the particular SOP. The SOPs can be cross-correlated to, for example, a QPM and QSPs, allowing for the quality system to be fully enacted and followed throughout the enterprise. The SOPs also can be cross-correlated to other modules, such as a task module. Cross-correlation with a task module can include tasking a member of the enterprise with updating a SOP, ensuring that a task defined by an SOP is completed by a member, and so forth. Also, SOPs can be standardized among (and consistently utilized by) all departments or divisions of the enterprise. Moreover, an audit trail of all changes and edits to operating procedures can be maintained.

C. Forms Module

A forms module can be configured to store some or all of the forms required for (or helpful to) achieving a QSC, i.e., Level 4 documentation, or other forms required for other certifications. The forms module also can be configured to manage and control such forms, as well as any other forms maintained by the enterprise, examples of which include: forms required by state, federal, or local regulatory agencies; riders for work in progress; vacation request forms; travel request forms; and requisition forms. In this configuration, a form library can be provided with standardized and customized forms necessary for (or related to) the enterprise. Forms in the form library can be assigned unique identifying numbers, which can allow for easy indexing and searching, and which also can assist in tracking forms for audits.

According to an example embodiment of the invention, a forms module can include routines for creating, editing, and printing forms, as well as routines for indexing and searching forms. Members (e.g., employees, managers, vendors, etc.) can have access to the forms on a restricted or non-restricted basis. Members can be directed to forms in the forms library from other modules by, for example, hyperlinks contained within the other modules' routines.

### III. Operating an Enterprise

Although one aspect of the invention is to enable an enterprise to obtain a QSC, the invention is not so limited. Another aspect of the invention is that it can be used to maintain certification and operate an enterprise in an efficient manner, as discussed above in detail in connection with FIG. 1. The modules discussed below can be used according this aspect of the invention. However, those having skill in the relevant arts will recognize that these modules can be used according to other aspects of the invention, and also that modules not discussed below also may be used.

A. Task Module

A task module can function to delegate tasks to members of an enterprise, and also to inform members as to the status of their assigned tasks. In delegating a task, a member can be informed of the necessary requirements for completing a task, as well as any additional information critical to the task's completion (e.g., due date). Once a task has been delegated, the member(s) responsible for the task can be informed via an alarm (e.g., an email, a pop-up window, etc.) or a similar reminder of any pending due dates for the task. The member(s) can also be informed if the task becomes overdue.

The task module may also be configured to assign subtasks, i.e., tasks which must be performed in order to complete a given main task. Subtasks may be assigned to the same member as a main task is assigned, or to one or more different members. In this manner, the task module can assign all aspects of a given task to members of an enterprise. The task module further can be configured to provide members with real-time status updates of their assigned tasks (or subtasks).

The task module also can function to provide managers with oversight of delegated tasks. For example, managers can view tasks lists (e.g., a list of daily tasks and a list of all task currently assigned to an individual member) to ensure that delegated tasks have been completed by their assigned members. Managers also can be alerted if a delegated task is delayed or not completed.

Like other modules in the present invention, the task module can be cross-correlated with other modules, such as, for example, QPM, QSP, and operating procedure modules. For example, if a particular operating procedure in an operating procedure module includes a step of performing a particular task, the task module and the operating procedure module can be cross-correlated in such a fashion that a member currently performing that task can be identified, or members who have performed that task in the past can be identified.

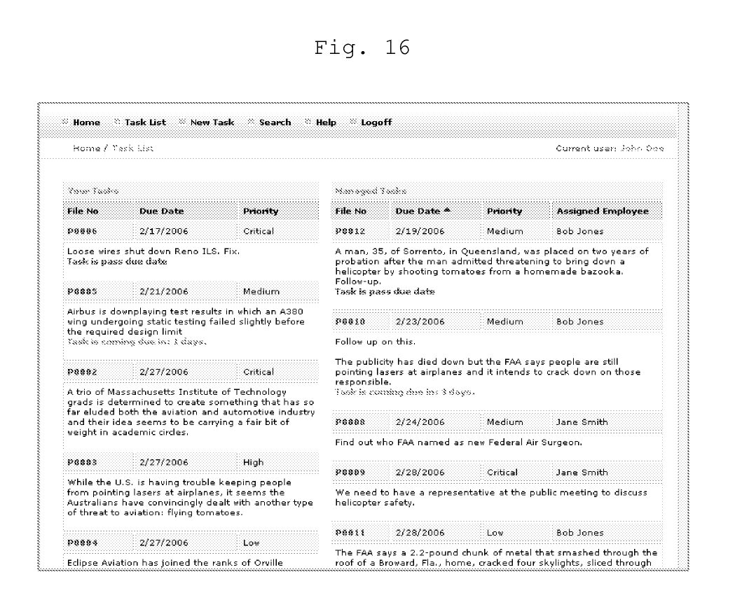

Information entered into, included with, and/or stored by an example task module may include: status, priority, type, review date, due date, assigned member, assigned manager, and task description. Status information may be, for example, a setting which allows for a task to be set as either open, i.e., active, or closed, i.e., inactive. Priority information can allow for a task to be ranked in importance relative to other tasks. For example, the priority information may allow for multiple tasks, which must be completed within a particular time period, to be addressed or completed in a specific order. Type information can allow for tasks to be grouped together. In this manner, tasks originating from the same project, due in the same time period, or otherwise similar in nature can be grouped. Review date information can be the date on which a task will be provided in a task list, e.g., the task list illustrated in FIG. 16 and described below. Due date information can be the date by which a task must be completed. Assigned member and assigned manager information can be the member currently assigned to a task and the manager currently assigned to manage a task, respectively. Task description information can include descriptions of the task, and corresponding notations.

According to an example embodiment of the invention, a task module can include routines for: listing tasks, creating tasks, editing and changing tasks, task file viewing, task filing, and task searching. FIG. 16 illustrates a display window of a task listing routine according to an example embodiment of the invention. The task list can provide an overview of all tasks or of particular tasks (e.g., tasks for which a review date has occurred) through the listing of information associated with the tasks, such as the information described above. The task list can be sorted according to various criteria, e.g., task number, due date, priority, and assigned member.

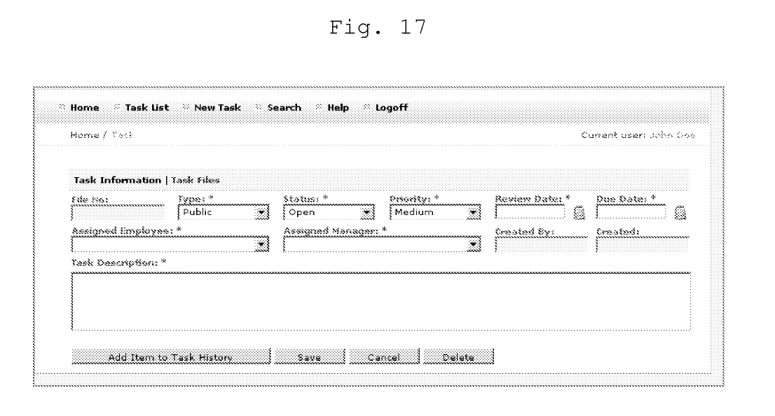

FIG. 17 illustrates a display window of a task creation routine according to an example embodiment of the invention. The creation of a new task can involve providing the task module with various kinds of information, such as the information described above. In some cases, information can be selected or chosen from pre-set options or fields, as may be the case with type, status, priority, assigned member (e.g., employee, manager, etc.). In other cases, information can be entered into a blank field, as may be the case with task number, review and due date, task creator, and task description. Various kinds of information may be required to create a new task, while other kinds of information may simply be optional for the creation of a task. Upon the creation of a task, an identification number can be assigned to the task. The identification number can allow for material associated with the task (e.g., printed documents) to be identified as belonging to or corresponding to the particular task. The identification number also can allow for both electronic and printed materials to be filed in an orderly manner.

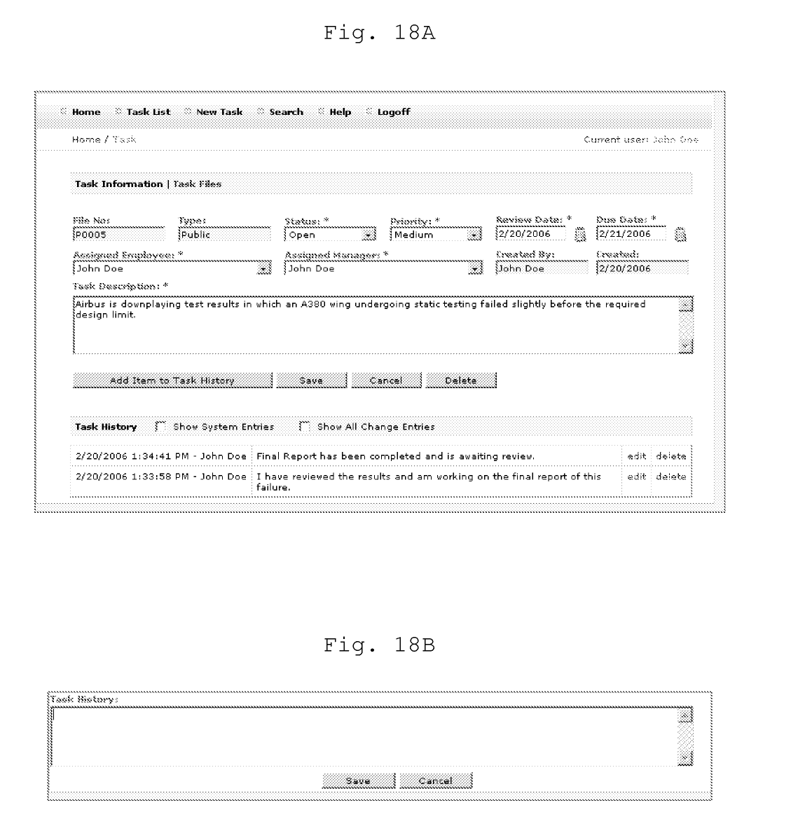

FIG. 18A illustrates a display window for a task editing routine according to an example embodiment of the invention. Task editing can be performed following the creation of task, an example of which can be performed according to the task creation routine described above in connection with FIG. 17. Task editing can involve changing information previously entered or selected during the creation of a task, and can also involve adding information (e.g., information optional to the creation of a task that was not entered or selected at the time of creation). Task editing also can involve deleting a task. Task editing further can involve adding, editing, or deleting task history items. FIG. 18B illustrates a display window for a task history adding routine according to an example embodiment of the invention. Adding a task history item can include entering a message or text (manually and/or automatically), which can then be stored by the task module, and viewed via a task editing routine, such as that illustrated in FIG. 18A.

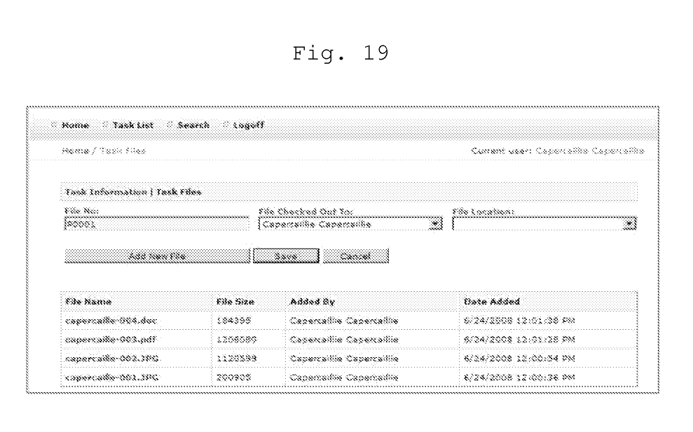

FIG. 19 illustrates a display window for a task file routine according to an example embodiment of the invention. Task filing can allow members to keep track of individual files (both electronic and printed) associated with a particular task, for example, by scanning bar codes provided on or fixed to printed copies and storing the data into the task module (and/or any other appropriate module). Task filing can include checking out a file to a member (by assigning the file to the member), locating a file at a particular location (e.g., a member's office), and entering in an electronic file location (if applicable). Task filing further can include the transmission (e.g., uploading) of electronic files to the task file routine for storage in (or association with) the task module. In this manner, one or more electronic files can be attached to (or associated with) one or more particular tasks.

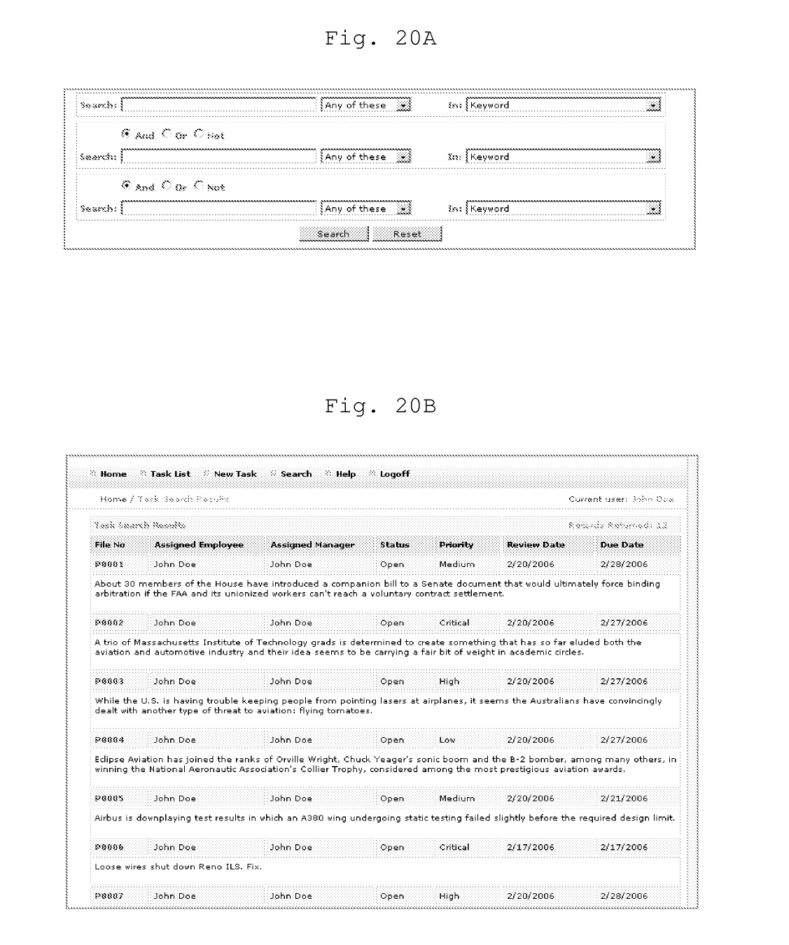

FIGS. 20A and 20B illustrate display windows for task searching routines according to an example embodiment of the invention. In the task searching routine illustrated in FIG. 20A, search terms can be entered into various fields. Search locations for entered terms can be selected; such locations can include any of the informational fields described above. Boolean search operators also can be selected. Following performance of a searching routine, a search result routine, such as that illustrated in FIG. 20B, can be performed. Search results can be displayed in tabular format, and can be sorted according to various headings.

The task module can be used by managers to track the status of members' tasks. In this manner, members can be held accountable for the timely performance of their tasks, and managers can be held accountable for overseeing all tasks performed by the enterprise. Moreover, a task module can be configured to provide a work history of completed tasks. A work history can be used in various ways, such as to improve processes performed to complete future tasks, and to provide feedback to managers and members.

By virtue of the example features and routines described above in connection with the task module, tasks (and subtasks) can be assigned to members (and/or managers) of an enterprise. Alarms or other reminders can be issued if a task is overdue, incomplete, or otherwise requiring intervention, allowing members and managers to identify delayed tasks and/or performance bottlenecks occurring in the operation of the enterprise. Alarms can be issued to, for example, an email address or a terminal (e.g., desktop computer, BlackBerry, PDA, etc.). A task can be automatically or manually escalated to the attention of a manager (or management level) if the delay on a task exceeds a predetermined period of time. Moreover, after another predetermined period of time, a task can be automatically or manually further escalated to a higher management level in the event that the initial management level was notified of the overdue task or delayed task, yet failed to have the task performed. Such escalation can continue through an enterprise's management hierarchy. Managers and members can also have the ability to search previous tasks, allowing for review of tasks performed. Moreover, an audit trail of all activities related to a task can be maintained. The audit trail, like an audit trail maintainable by any of the other modules described herein, can be electronic, archivable, revision-controlled, and access-restricted.

B. Calibration Module

A calibration module can be configured to record calibrations of gauges and other equipment, and to schedule future calibrations. The calibration module can include an inventory of all gauges, instruments, tools, and other calibrated equipment in use by the enterprise. The inventory can be sorted or stored according to various criteria (e.g., member, manager, department, etc.). The calibration module also can include a timetable listing the availability of each gauge, which can be used to schedule calibrations. The calibration module also can be configured to maintain an electronic and/or printed audit trail of calibrations performed, as well as an any maintenance notes made during (or after) each calibration.

According to an example embodiment of the invention, a calibration module can have two sub-modules: a gauge record module and a gauge type module. (Sub-modules, such as the gauge tracking module and the calibration module, may be referred to herein as “modules” or “sub-modules,” depending upon the context in which the term is used.) In the gauge type module, records pertinent to the types of instruments and/or equipment used by the enterprise are created and stored. These records can be merely instrument model information and the like, and not information specific to individual instruments deployed by the enterprise. In the gauge record module, records pertinent to individual instruments used by the enterprise are created and stored. Example gauge and gauge type modules are described below.

Information entered into, included with, and/or stored by an example gauge type module can include type, accuracy, lead time, and calibration instruction information. Type information can be descriptive information that allows for instruments to be grouped together. In this manner, instruments that perform similar functions, have like manufacturers, or otherwise are similar in nature can be grouped. Accuracy information can be an amount of error permissible in the operation or configuring of an instrument. Lead time information can be a predetermined period of time required for calibrating an instrument. Lead time information can be the amount of time required to have the instrument calibrated on or before a calibration date, which is described below. Calibration instruction information can include text or other descriptions, which may be useful or required for the performance of a calibration.

Information entered into, included with, and/or stored by an example gauge record module may include: status, serial number, control member, model number, manufacturer, type, location, owner, calibrator, accuracy, review date, next calibration date, calibration date, and gauge identifier information. Status information may be, for example, a setting which allows for an instrument to be set as either open, i.e., active, or closed, i.e., inactive. Serial number information is, for example, the serial number assigned by the instrument manufacturer. Control member information can be the individual member or manager responsible for managing the instrument, its calibration state, and/or its use. Manufacturer information can include the name of the instrument manufacturer, and model number information can include a model number assigned by the manufacturer. Location information is a description of where the instrument is located, and can include locations both on-site and off-site. Owner information can be the name or description of the individual or entity that owns the instrument, and may or may not be an individual or entity associated with the enterprise. Calibrator information can be the name or description of an individual or entity that performs calibrations of an instrument, and can be a person associated with an enterprise (e.g., a member) or a third party. Accuracy information can include the tolerable amount of a particular error associated with the machine. Review date information can be the date on which the particular calibration record will appear on a calibration list (and thus informing members of the pending calibration). Next calibration date information can be the date by which the instrument must be calibrated and/or the date on which the current calibration expires, and calibration date information can be the date on which the most recent calibration was performed. Gauge identifier information can be a number, text, or combination thereof that uniquely identifies each gauge record.

As with other modules described herein, information can be entered into the calibration module (and its sub-modules) by, for example, manual entry or by scanning a bar code. In the example of bar code entry, a bar code can be provided on (or fixed to) equipment associated with the calibration module. Members of the enterprise then can readily and accurately enter information into the calibration module via equipment bar codes.

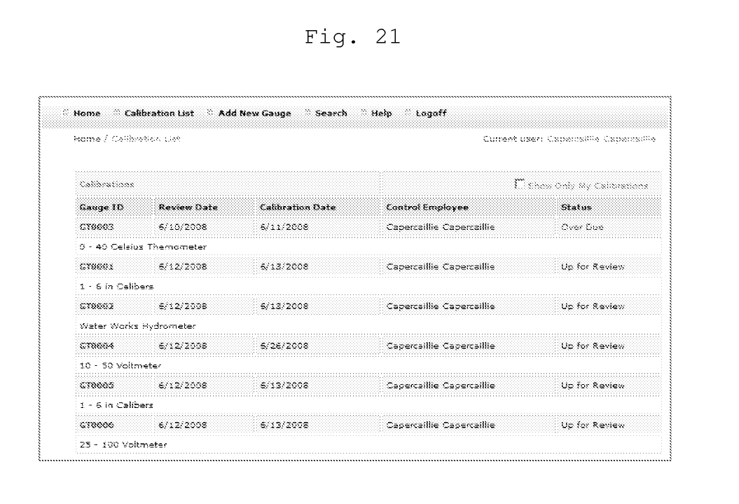

According to an example embodiment of the invention, a calibration module, which includes gauge type and gauge record sub-modules, can include routines for: creating and editing gauge types; creating, listing, and editing gauge records and searching for gauge records and gauge types. FIG. 21 illustrates a display window for a gauge record listing routine according to an example embodiment of the invention. The gauge record list can provide an overview of all gauge records provided for review. The gauge record list can be sorted according to various criteria, e.g., gauge identifier, review date, calibration date, control member, status, and environmental conditions at time of review.

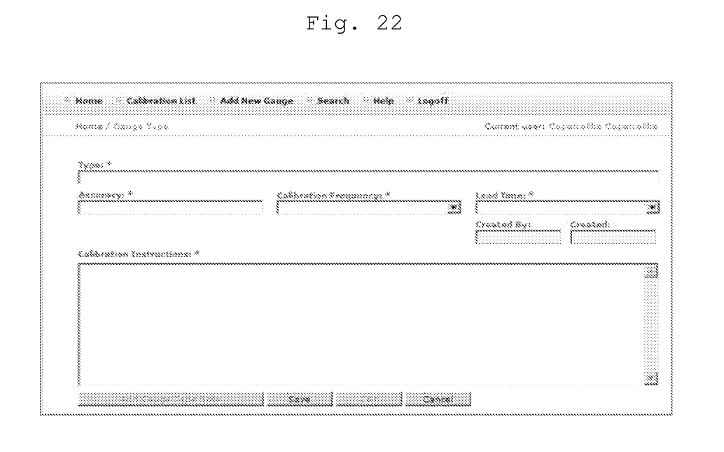

FIG. 22 illustrates a display window of a routine for creating a gauge type. The creation of a new gauge type can involve providing the calibration module with various kinds of information, such as the information described above with respect to the gauge type sub-module. In some cases, information can be selected or chosen from pre-set options, as may be the case with calibration frequency and lead time information. In other cases, information can be entered into a blank field, as may be the case with type, accuracy, and calibration instruction information. Various kinds of information may be required to create a new gauge type, while other kinds of information may be optional for the creation of a gauge type.

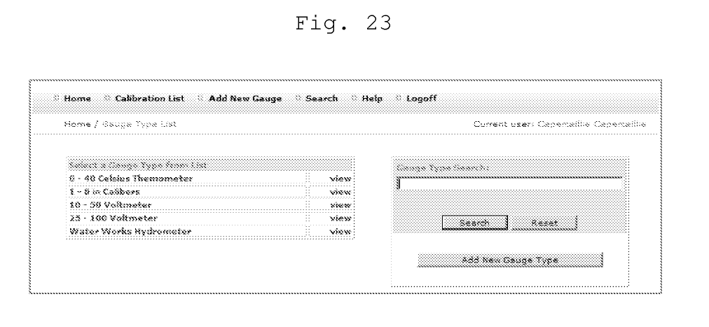

FIG. 23 illustrates a display window of a routine for listing all active gauge types. By this routine, a particular gauge type can be selected for viewing. Also, a gauge type search routine can be accessed, the performance of which can lead to a display window for showing search results (not shown).

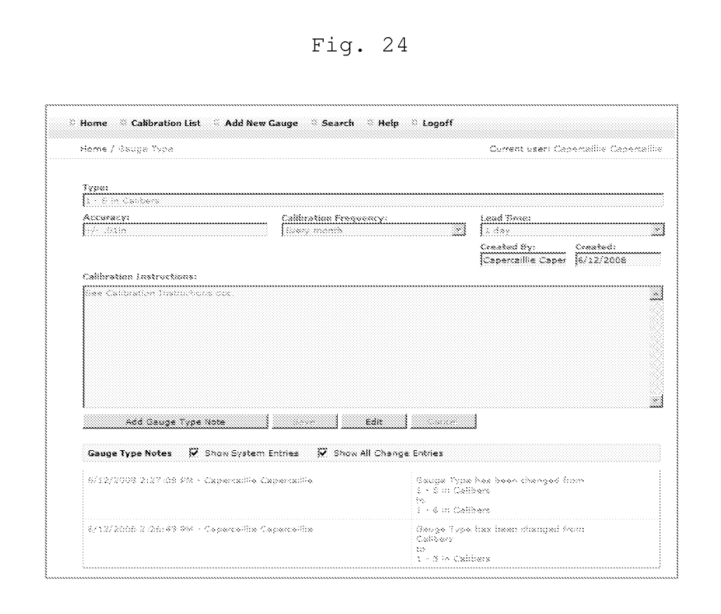

FIG. 24 illustrates a display window of a routine for editing a gauge type. From this routine, the information associated with a gauge type can be added and/or edited. Gauge type editing can be performed following the creation of a gauge type, an example of which can be performed according to the gauge type creation routine described above in connection with FIG. 22. Gauge type editing can involve changing information previously entered or selected during the creation of a gauge type, and also can involve adding information (e.g., information optional to the creation of a gauge type, which was not entered or selected at the time of creation).

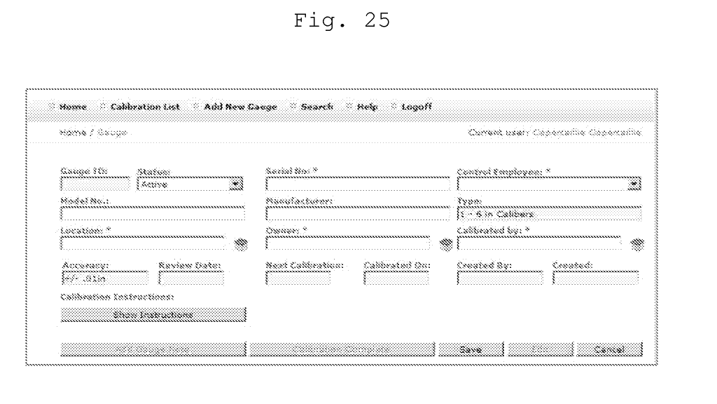

FIG. 25 illustrates a display window of a routine for adding a new gauge record (i.e., a new calibration record). The routine of FIG. 25 is similar to the routine for adding a new gauge type (as shown in FIG. 22), except that a gauge record contains information specific to an individual instrument deployed by the enterprise. For example, a gauge type can be a particular thermometer manufactured by a particular manufacturer. However, an enterprise may have fifty of these particular thermometers deployed throughout the enterprise. Thus a gauge record can be made for each of the fifty thermometers.

The creation of a new gauge record can involve providing the calibration module with various kinds of information, which may include a gauge type and/or information described above with respect to the gauge type sub-module. In some cases, information can be selected or chosen from pre-set options, as may be the case with status and control member information. In other cases, information can be entered into a blank field, as may be the case with, for example, serial number, model number, and manufacturer information. Additionally, some information can be entered by performance of a secondary routine (e.g., a location routine, an owner routine, and a calibrator routine), as described below. Various kinds of information may be required to create a new gauge record, while other kinds of information may be optional. Upon the creation of a gauge record, a gauge identifier (e.g., an identification number) can be assigned to the particular record by the calibration module. The identification number for a gauge can be used in a fashion similar to identification numbers for tasks, as previously described.

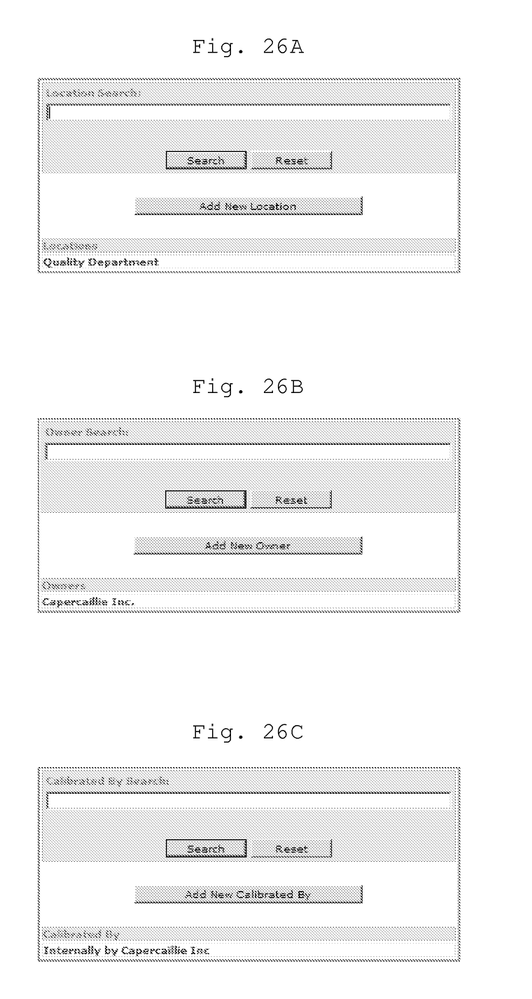

FIGS. 26A-26C illustrate display windows of various secondary routines, which may be accessible from a gauge record creation routine. According to an example embodiment of the invention, these routines can be accessed via pop-up windows from the gauge record creation routine. In the model number routine shown in FIG. 26A, all current locations can be listed. From this list, a location can be selected for entry in the gauge record creation routine. The search criterion can be used to restrict the locations listed. In the owner routine shown in FIG. 26B, all currently active owners can be listed. From this list, an owner can be selected for entry in the gauge record creation routine. The search criterion can be used to restrict the owners listed. In the calibrator routine shown in FIG. 26C, all currently active calibrators can be listed. From this list, a calibrator can be selected for entry in the gauge record routine. The search criterion can be used to restrict the calibrators listed. Additionally, there may be secondary routines other than those described in connection with FIGS. 26A-26C. Such secondary routines may be used for searching for, creating, and/or selecting information necessary or optional to the creation of a gauge record.

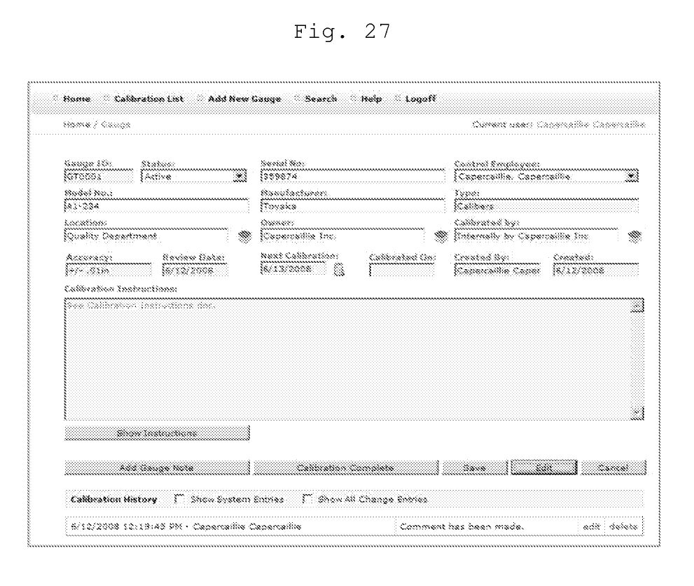

FIG. 27 illustrates a display window a routine for editing a gauge record according to an example embodiment of the invention. Like gauge type editing, gauge record editing can be performed following the creation of a gauge record. Gauge record editing can involve changing information previously entered or selected during the creation of a gauge record, and also can involve adding information. Gauge record editing also can involve adding, editing, or deleting gauge notes and calibration history items.

By virtue of the example features and routines described above in connection with the calibration module, inventories of gauges and instruments can be maintained. An inventory can be viewed by, for example, department or member responsible for particular gauges (and/or instruments). A record of previous calibrations and maintenance also can be maintained. Alarms or other reminders for an upcoming calibration or maintenance can be provided, along with timetables of gauge and instrument availability. Moreover, an audit trail of gauge and instrument calibrations can be maintained, along with records of maintenance notes.

C. Chemical Module

A chemical module can be configured to track chemicals used by the enterprise. In particular, the chemical module can be used to track hazardous materials, thus promoting compliance with any regulations (e.g., OSHA), as well as member safety. As one aspect of tracking chemicals, the chemical module can store or prepare key information about chemicals currently in use. Such information can be entered into the module by members and/or managers, and can include, without limitation: manufacturer product and manufacturer contact information, material safety data sheet (MSDS), technical data sheet (TDS), description, and storage requirements (e.g., maximum and minimum storage temperatures). The information can be entered into the module manually or automatically (e.g., by scanning a bar code). The chemical module also can be configured to issue alarms or reminders under specified circumstances such as, for example, the pendency (or passing) of an expiration date or the complete use of a certain chemical. Such alarms can be issued to one or more members or managers.

A chemical module also can be configured to publish handling instructions for one or more chemicals. Such instructions can be enterprise-specific, and can be established by a member or manager of the enterprise. Notations regarding each chemical also can be made by members and/or managers. Such a configuration also can include the uploading and storage of electronic MSDS and TDS files, as well as other important handling documents, for association with the chemical module. In this manner, a repository for MSDS and TDS can be accessible by members and managers. The chemical module further can be configured to monitor and/or record all handling (e.g., use, movement) of a chemical. In this manner, a history of each chemical can be maintained, allowing for an audit trail of chemicals used by the enterprise, and establishing accountability by members and/or managers for such chemicals.

Information entered into, included with, and/or stored by an example chemical module may include: emergency contact information, status, MSDS, TDS, manufacturer, manufacturer part number, description, and maximum and minimum storage temperatures. Status, manufacturer, manufacturer part number, and description information for the chemical module can correspond to similarly-named items described above in connection with the task module and/or calibration module. Emergency contact information can include telephone numbers and/or addresses to contact in the event of an emergency, and can be provided by the manufacturer. MSDS information can include whether a material safety data sheet for a particular chemical has been filed or is otherwise accessible, and may include details for accessing the data sheet. TDS information can be similar to MSDS information, but pertaining to technical data sheets. Maximum and minimum storage temperature information can be used to provide a temperature range at which a chemical may be safely and properly stored without damage and/or degradation.

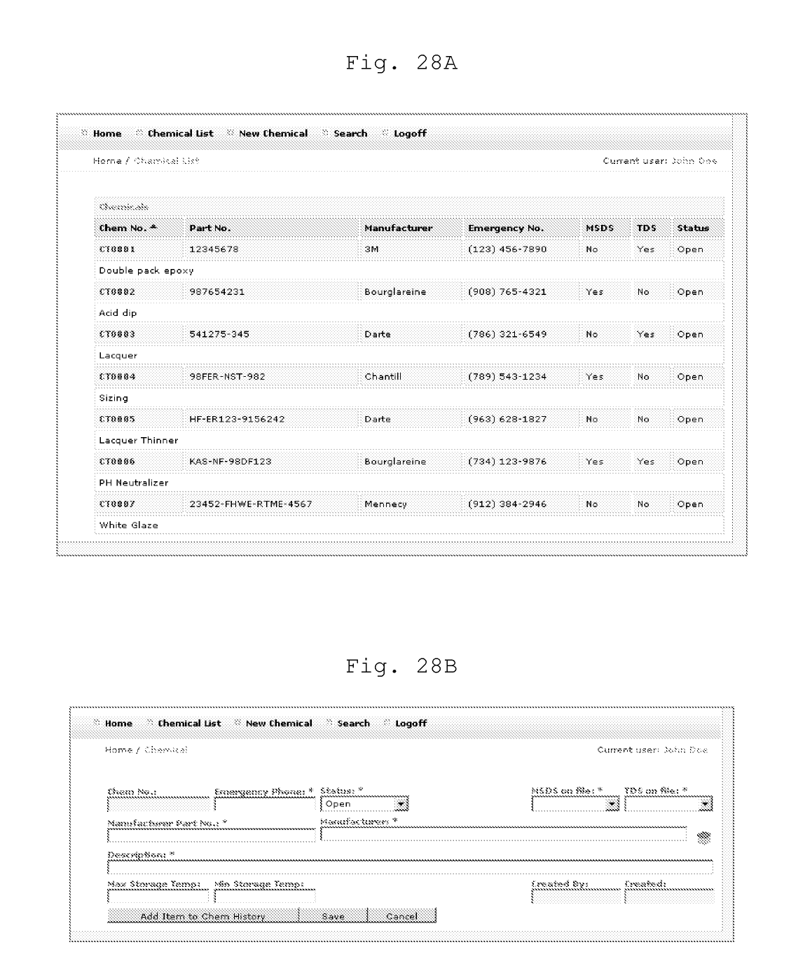

According to an example embodiment of the invention, a chemical module can include routines for: listing chemicals, creating chemical records, editing chemical records, and searching for chemical records. FIG. 28A illustrates a display window of a chemical listing routine according to an example embodiment of the invention. The chemical list can provide an overview of all chemicals in use (or previously used) by the enterprise. The chemical list can be sorted according to various criteria, e.g., chemical number, manufacturer part number, manufacturer, emergency contact, MSDS and TDS, and status.

FIG. 28B illustrates a display window of a chemical record creating routine according to an example embodiment of the invention. The routine illustrated in FIG. 28B can operate in a manner similar to the creating routines described above with respect to FIGS. 16 and 25. In particular, the routine of FIG. 28B can be used to create a new chemical record through the entry and/or selection of information.

The chemical module also can include a chemical editing routine, a routine for searching chemical records, and secondary routines (accessible from, for example, the chemical record creating and chemical record editing routines) for entering and/or selecting manufacturers, and for adding chemical history items. Illustrations of these routines are not shown. However, features of these routines can correspond to similar routines illustrated (and described) above in connection with other modules.

By virtue of the example features and routines described above in connection with the chemical module, information regarding chemicals (and materials) used and/or stored by an enterprise can be tracked. Tracking efficiency and accuracy can be increased by configuring the module to enter information into routines automatically (e.g., scanned bar code data can be used to populate various information fields). Enterprise-specific instructions for chemical and material handling can be published, and an audit trail of all activities related to the handling of chemicals and materials can be maintained.

D. Inventory Module

An inventory module can be configured to track raw materials, supplies, and other inventory used by (or otherwise coming into) the enterprise. Routines performed by the inventory module can include routines similar to those described above in connection with the chemical module. Bar codes can be provided on or fixed to all inventory entering, processed at, or otherwise coming into an enterprise, which can allow for easy entry of inventory into the inventory module. In this manner, an enterprise's complete inventory can be located, tracked, replenished, reordered, etc.

E. Skill Module

A skill module can be configured to indicate which members (and managers) are trained in the particular procedures used or employed by an enterprise. Such procedures may include physical tasks (e.g., operation of machinery) and mental skills (e.g., management training and customer service training). In an example embodiment of the invention, the procedures associated with the skill module can be (or can include) SOPs, which are described above in connection with an operating procedure module. Moreover, the skill module can correlate significantly with an operating procedure module; in fact, in an example embodiment of the invention, a skill module can be a sub-module of an operating module. However, in other example embodiments, the skill module can be a standalone module.

A skill module also can be configured to motivate members to achieve proficiency in various procedures. For example, a points system (or other suitable grading scheme) can be configured or set up by the module. In the example of a points system, a member can earn points for each procedure in which the member is trained; the number of points awarded for training in a procedure can depend upon the skill level to which the member is trained, as well as the maximum number of points available for the procedure. The maximum number of points per procedure can be dependent upon (and/or proportional to) the weight information for the procedure (discussed above in connection with SOPs and an operating procedure module). Then, through the skill module, a member can view and/or adjust goals and other targets or point totals, which may be voluntarily or involuntarily assigned to the member, i.e., in some instances members may set their own goals, and in other instances members may have their goals assigned by, for example, the enterprise management. A skill module also can track members' specific skill levels for procedures in which they have been trained. The module further can show members their target skill levels for procedures in which they will be training or reviewing.

With a points system (or other grading) in place, an enterprise can reward members who perform well (and/or punish employees who perform poorly). Rewards can include promotions, salary raises, etc. Because members can readily access and track their progress via the skill module, training in procedures can be self-motivating, i.e., members wishing to receive rewards may sign themselves up for training and also train to achieve maximum points and/or skill levels. Therefore, an enterprise's use of a skill module can result in well-trained, highly-motivated members. Moreover, in the example embodiment where the procedures of the skill module include SOPs, an enterprise's use of a skill module can result in members who effectively and knowledgeably perform SOPs associated with the enterprise's QPM and QSPs. In turn, this can assist the enterprise in achieving (and/or maintaining) a QSC.

A skill module further can be configured to manage an enterprise's job requirements, as well as procedures associated with the job. An enterprise's jobs can be any positions within (or associated with) the enterprise, which can be held, maintained or performed by a member. Procedures associated with a job can include required and recommended procedures. Required procedures are those procedures on which a member must be trained prior to the member holding a position, while recommended procedures are those on which it is recommended that the member be trained. A job's requirements (and any associated procedures) can be set forth by a QMS standard or other regulatory body, a QPM or QSPs, and/or can be determined by the enterprise or a third party. By configuring a skill module in this manner, the correlation between an enterprise's positions and procedures can be easily viewed, managed, and modified, thereby streamlining this aspect of an enterprise's operation. The skill module further can be correlated to other modules. For example, if a SOP (or other procedure) is created or revised, required or further training for members impacted by the creation or revision can be automatically or manually flagged, scheduled, or otherwise communicated to the members (as well as other members, e.g., management).

Information entered into, included with, and/or stored by a skill module may include: total points, target points, goal points to date, performance goal date, review date, trained date, maximum points, and target rating information. Total points information can be the total number of points a member has earned. Target points information can be a number of points a member wishes (or must) earn, and can be linked to a particular date (e.g., 100 target points by the end of the current month). Goal points to date information can be the number of points a member has earned towards a target number of points since the date the goal was set. In this manner, members (and management) can gauge their progress towards achieving the goal. Performance information can include total performance, goal performance to date, and target performance information. Performance information can be dependent upon points information, as well as, for example, skill ratings of procedures (e.g., SOPs). In this example, a member who has trained to a low level in many skills (or procedures) can have a high number of points but a low total performance, while a member who has trained to a high level in a few skills can have a low number of points but a high total performance. Thus, performance information can be used to assess aspects of a member's skill training other than those assessed through points information. Goal date information can be a date by which a member should train in a particular procedure. Review date information can be a date on which a member is assigned to review a procedure in which the member was previously trained. Trained date information can be a date on which a member was trained in a procedure. Target rating information can be a skill level to which a member should be trained. The target rating (and a skill level in general) can be a specific number, which can correspond to a distinct aspect or level of a procedure in which a member has been trained. For example, a rating of “1” can correspond to novice knowledge of the procedure, while a rating of “5” can correspond to a teacher's knowledge of the procedure (and may also allow the member to teach or train others in the procedure).

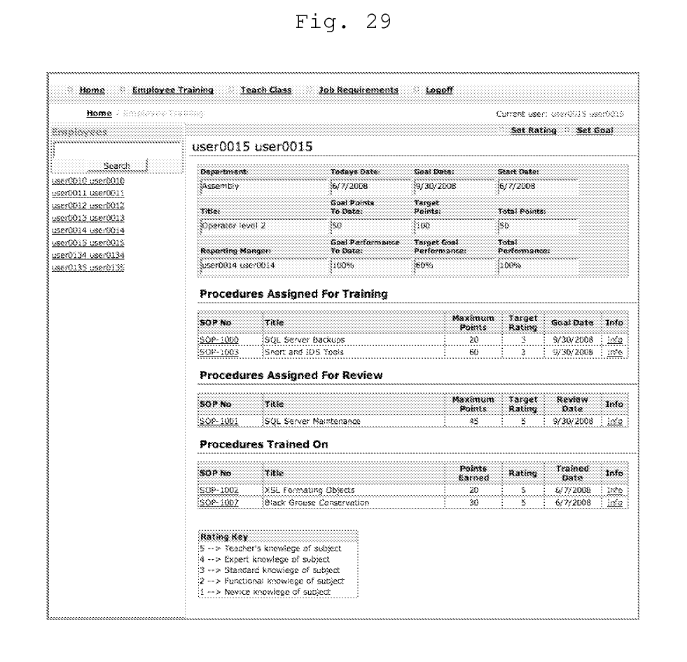

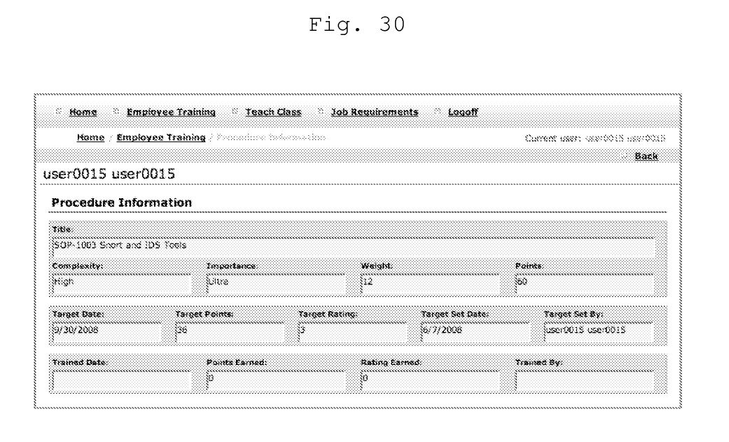

According to an example embodiment of the invention, a skill module can include routines for: viewing goals and procedures, editing goals, assigning procedures, and rating procedures. A skill module further can include routines for viewing and editing jobs. FIGS. 29 and 30 illustrate display windows of a routine for viewing goals and procedures. In this routine, members can track procedures in which they have trained, need to train, and need to review. Specific information for these procedures, including points and rating information, is accessible; overall goal and point data is also accessible. Management of the enterprise also can track members' training progress through this routine. In the routine of FIG. 30, information specific to the procedures shown in FIG. 29 are displayed.

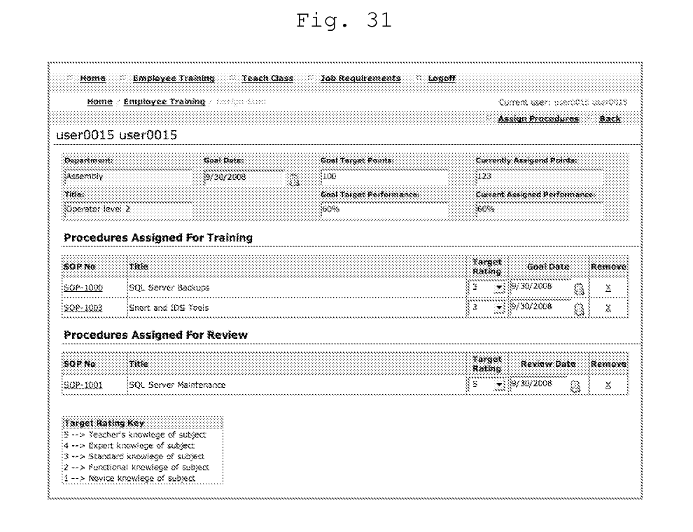

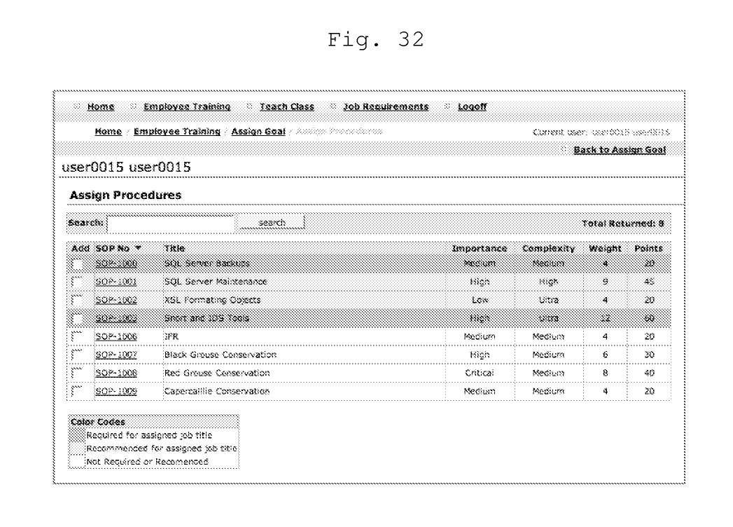

FIGS. 31 and 32 illustrate display windows of routines for editing goals and procedures. Access to these routines can be provided to non-management members, enterprise management, or both, depending upon how an enterprise chooses to have member goals and procedures set. In the routine of FIG. 31, goals for points and ratings, both overall and specific to assigned procedures, can be set for a particular member. In the routine of FIG. 32, procedures can be assigned to a particular member. Procedures can be labeled or otherwise coded to show whether individual procedures are required or recommended for the member's job.

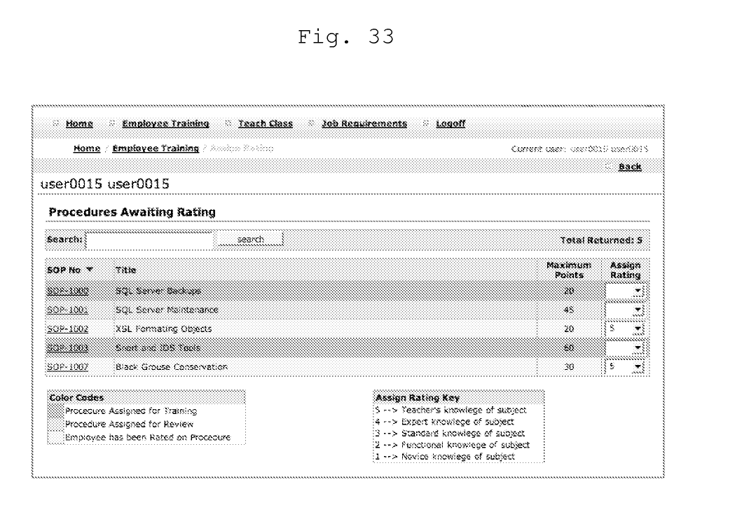

FIG. 33 illustrates a display window of a routine for rating a member on procedures in which the member has been trained. This routine may be accessed when, for example, a member recently has been trained on a procedure, and the trainer wishes to rate the member on that procedure. As such, access to this routine can be restricted to training members (e.g., those having a training level of “5” in a particular procedure) and enterprise management. (However, access need not necessarily be restricted in this manner.) Similar to the routine of FIG. 33, the skill module also can include routines (not shown) for selecting multiple procedures and rating all (or some) of the members trained on the selected procedures. Through performance of these routines, multiple members can be rated more quickly than if each member is rated individually, i.e., through performance of the routine of FIG. 33 for each member.

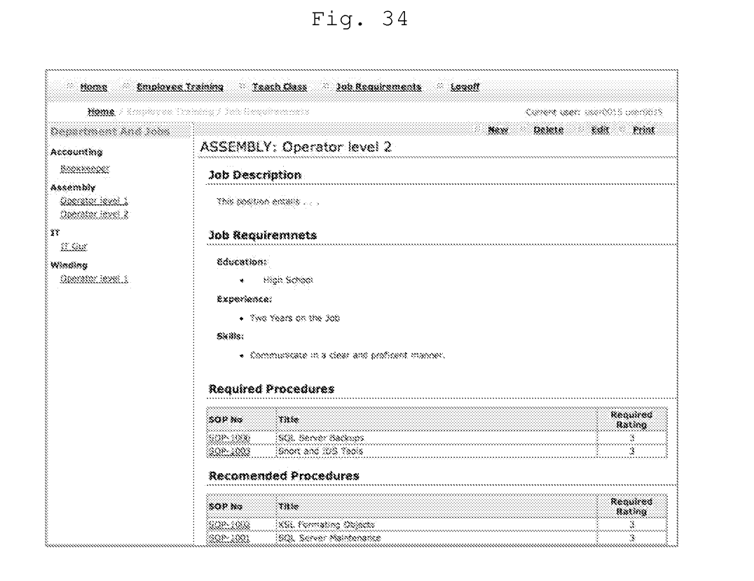

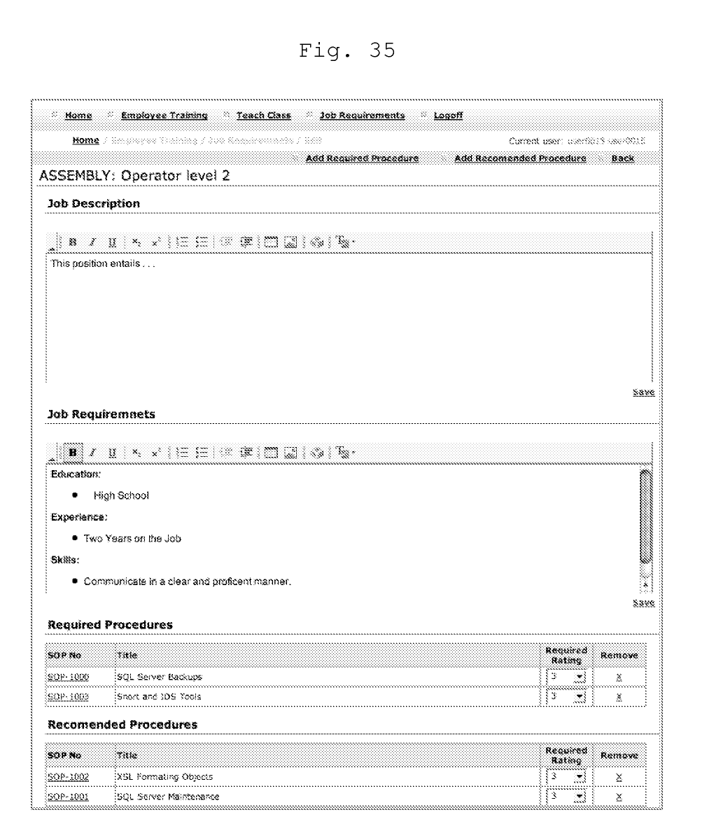

FIG. 34 illustrates a display window of a routine for viewing job information. By performance of this routine, a job's description, requirements, and associated procedures can be viewed. Furthermore, this routine can provide a list or hierarchical display of all (or some) of the enterprise's jobs. This list can be categorized by department or any other suitable category. From this list, information for other jobs can be accessed. FIG. 35 illustrates a display window of a routine for editing job information. From this routine, a job's description and requirements can be added and/or edited, and a job's associated procedures can be edited. The skill module also can include routines (not shown) for adding new jobs and adding required procedures and recommended procedures to jobs.

By virtue of the example features and routines described above in connection with the skill module, member training progress can be tracked, and members can be motivated to seek out training in new procedures and train to high levels on procedures. Furthermore, enterprise jobs can be easily correlated to procedures, ensuring that members are appropriately qualified and trained for their jobs.

### IV. Performing Diagnostics

Still another aspect of the invention is that it can be used to perform diagnostics on (or assist in diagnostics performed by) an enterprise in an efficient and cost-effective manner. Diagnostic actions can include maintaining, restocking, retooling, and/or replacing resources, supplies, raw materials, and equipment used by the enterprise, and recalling products (or repeating the performance of services) output by the enterprise. Diagnostic actions also can include correcting or preventing nonconformities which arise in the operation of the enterprise. When employed in conjunction with other modules of the present invention, a diagnostic function (which may be performed by, for example, a recall module, as described below, or any other module or sub-module) can create a “closed loop,” whereby output or functions from other modules can be acted upon or transformed to ensure proper, efficient, and superior management of the enterprise, in full compliance with regulatory and/or commercial requirements.

The modules discussed below can be used according this aspect of the invention. However, those having skill in the relevant arts will recognize that other modules not discussed in connection with this aspect also may be used, and also that the module discussed below can be used according to other aspects of the invention, and also that modules not discussed below also may be used.

A. Recall Module

A recall module can function to track products and goods associated with the operation of the enterprise. Products tracked by the recall module may include, for example, chemicals having set storage periods and materials having expiration dates. Each product tracked by the recall module can be assigned a number to assist members in identifying tracked products. Each tracked product can also be assigned to one or more members, who are responsible for performing actions necessary in accordance with the recall module, e.g., disposal or recall. (A recall action in the context of the recall module also can be performed by a third party, e.g., a manufacturer of a product having an expiration date.) The accuracy and efficiency of the recall module can be increased by, for example, configuring the module to automatically enter information into its various routines (e.g., bar code data can be scanned by a member, with such data then processed by the module).

The recall module can be closely interrelated with a chemical (or other) module (if such a module is configured in a system such as suite 100), an example of which is described above in connection with FIGS. 28A and 28B. The recall module can be configured to issue alarms or reminders under specified circumstances such as, for example, the pendency (or passing) of an expiration date or the complete use of a certain chemical. Such alarms can be issued to one or more members or managers. The recall module also can be configured in such a way that there are multiple recall records associated with an individual chemical record. For example, an enterprise may have ten containers, each containing the same chemical. In this example, the chemical module can have one record of the chemical. However, the recall module can have one record of each container, i.e., ten records associated with the single chemical. Thus, each individual container can be tracked separately by the recall module, yet the basic chemical information can be accessed as a single record in the chemical module.

Information entered into, included with, and/or stored by an example recall module (and its associated routines) may include: recall number, status, review date, recall date, control member, pulled date, manufacturer, manufacturer part number, manufacturer lot number, and location. Status, review date, control member, manufacturer, manufacturer part number, and location information for the recall module can correspond to similarly-named items described above in connection with other modules. Recall date information can be a particular date or date range by which the product must be recalled. Pulled date information can include a date on which a recall was performed. Pulled date information also can be in the form of a time period (e.g., “within the last week”) or a time stamp automatically generated by the recall module. Manufacturer lot number information can be a specific lot, batch, or other grouping number associated with the product corresponding to the recall record. Manufacturer lot number information can be provided by the product manufacturer.

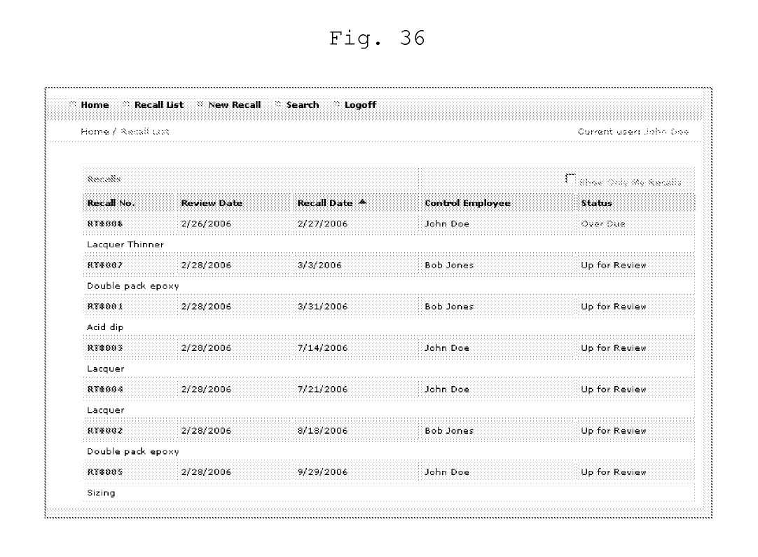

According to an example embodiment of the invention, a recall module can include routines for listing, creating, editing, and searching for recalls. FIG. 36 illustrates a display window of a recall listing routine according to an example embodiment of the invention. This recall listing routine can be similar in function to the listing routines described above in connection with other modules.

The recall module also can include routines for recall editing and recall searching, as well as secondary routines (accessible from, for example, the recall creating and recall editing routines) for entering and/or selecting manufacturer part numbers, and for adding recall history items and accessing calendar features. Illustrations of these routines are not shown. However, features of these routines can correspond to similar routines illustrated (and described) above in connection with other modules.

By virtue of the example features and routines described above in connection with the recall module, information about products, materials, and chemicals associated with an enterprise can be tracked. Tracking efficiency and accuracy can be obtained by through the automatic entry of information (e.g., scanning and processing of bar code data). In particular, information tracked by the recall module can pertain to, for example, age-sensitive materials or chemicals with expiration dates. Tracked information further can include where such materials were used and in what quantities. Alarms or other reminders can be issued for the recall or renewal of these products or a regulatory decision banning modifying, or limiting use of the products. Also, enterprise-specific instructions for their handling can be published, and records can be created (using, in some cases, data or output from other modules) indicating where the products have been used in the enterprises and what procedures have invoked use of the products. Moreover, an audit trail of all handling activities can be maintained.

B. Corrective Module

A corrective module can function to establish and/or maintain a quality management system within the enterprise. The corrective module can incorporate quality control policies and objectives, audit results, data analysis, and management reviews. According to an example embodiment of the invention, a corrective module can have two sub-modules: a corrective action module and a preventive action module. Example corrective action and preventive action modules are described below.

Corrective actions are those actions taken to eliminate nonconformities that arise within the enterprise, thus preventing the recurrence of such nonconformities. When configured to take corrective actions, a corrective module can include features such as: nonconformity cause determinations; nonconformity reviews (e.g., customer complaints); recurrence evaluations; nonconformity recordation; corrective action implementation, including the forwarding of corrective actions to third parties, e.g., suppliers; corrective action review; and backup or default actions when corrective action is not timely or effective. Corrective actions can include internal actions (i.e., those actions taken by the enterprise) and external actions. External actions may be taken by, for example, a supplier, a vendor, or a customer. External actions may or may not include a reporting requirement (i.e., that the entity taking the external action reports the outcome of the corrective action to the enterprise).

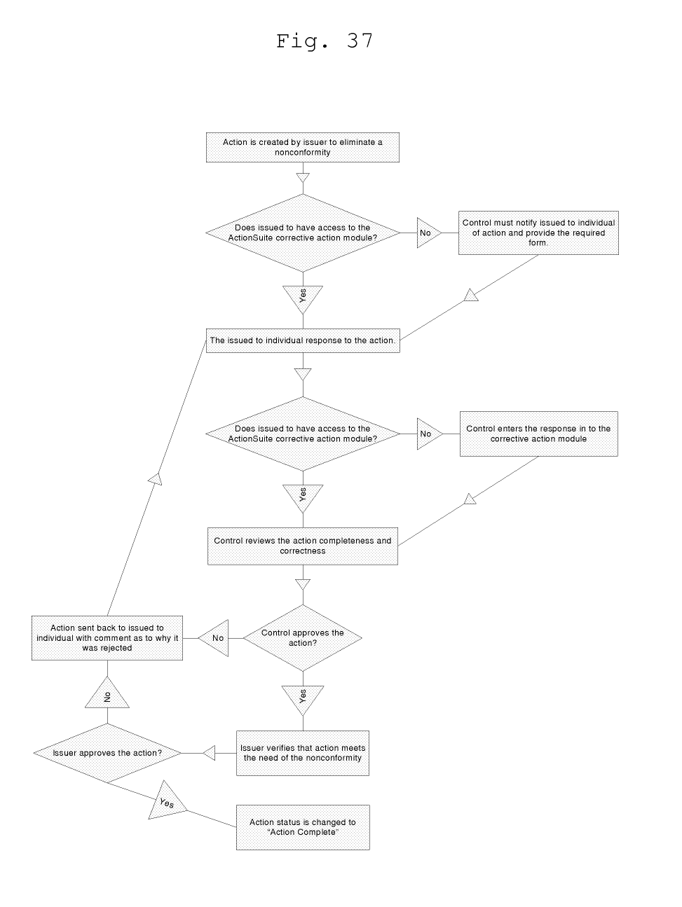

The functioning of an example corrective module can proceed as follows. If a nonconformity (e.g., a defective product manufactured by an enterprise) is discovered, a corrective action request is created by an issuer (e.g., a member of the enterprise). The issuer issues the corrective action to an issued-to member, who is responsible for completing the corrective action. Moreover, the module can assign the corrective action to a controller (e.g., another employee of the enterprise). The controller is responsible for ensuring that the corrective action is properly completed by the issued-to member. A corrective action may be initiated thereby, in which a determination of the root cause of a nonconformity, a defect, a failure, or the like, is facilitated by accessing relevant information or data from the corrective module and other modules in the system, and analyzing and manipulating that information. Such information can include, for example, data relating to which members have worked on a part at issue, what materials were used, whether the members had training required by applicable SOPs, etc. By virtue of an example aspect of the invention, all such information is available in the system for quick and efficient analysis and manipulation. Moreover, comprehensive and detailed reports and the like can be prepared for regulatory authorities (e.g., FAA, OSHA, etc.), for third parties (e.g., vendors, customers, etc.), and for use pursuant to investigatory proceedings, lawsuits, and the like. Once the corrective action has been completed, the controller and the issuer each verify that the corrective action satisfies the needs and/or requirements of the enterprise. This functioning of an example corrective module is shown in the flow diagram of FIG. 37.

Preventive actions are those actions taken to eliminate sources of potential nonconformities, thus preventing the occurrence of such nonconformities. When configured to take preventive actions, a corrective module can include features such as: potential nonconformity determinations; preventive action implementation; recordation of potential nonconformities and any preventive actions taken; and review of implemented preventive actions. Like corrective actions, preventive actions can include internal actions and external actions (with or without a reporting requirement).

A corrective module can be configured or based upon published standards for quality management systems (e.g., ISO9001 and AS9100B). If configured in this manner, the module can be used to establish adherence of an enterprise to such standards, improve the effectiveness of a quality management system already established, and/or to enable certification to such standards.

Information entered into, included with, and/or stored by an example corrective module and, in particular, a corrective action sub-module may include: action number, action category, status, source, violation, cost, issued-to member, control member, issuer, initiate date, response date, control review, issuer verification, nonconformity, root cause, corrective action, and containment action. Action number can be a number or designation automatically provided by the corrective module. Action category information can be the type of action to create or edit (e.g., corrective action or preventive action). Status information can be the current phase of the action, and can include the following designations: waiting issue, waiting response, waiting control review, waiting issuer verification, and action complete, as well as any other suitable designations. Source information can be the individual or entity determining the need for an action, and can include sources internal or external to the enterprise. Violation information can be a group or category into which an action can be placed or assigned, thus allowing actions to be grouped into meaningful or pertinent categories. Cost information can be a loss amount (e.g., money, time, etc.) expended to implement an action, or resulting from a failure to implement an action. Issued-to member information can be the individual or entity responsible for completing the response portion of an action. Control member information can be the individual or entity responsible for ensuring a response to an action is properly and timely completed. As described above, a control member can be responsible for approving or rejecting an action, depending upon whether the response to the action is appropriate to the needs of the enterprise. Issuer information can be the individual (e.g., a member or a manager) or entity that issues an action. Like a control member, an issuer can be responsible for approving or rejecting an action, depending upon whether the response to the action is appropriate to the needs of the enterprise. Issuer information may or may not correspond to source information. Initiate date information can be a date on which an action is created, or on which an audit action is assigned. Response date information can be a date on which a response to an action is expected to be completed by an issued-to member. Control review information can be a date on which a control member reviews a response to an action, while issuer verification can be a date on which an issuer reviews (and verifies) the response and the control review. Nonconformity information can be description of a nonconformity or other possible problem associated with a corrective action. Root cause information can be a description of one or more causes or sources of a nonconformity. Corrective action information can be a description of an action taken to correct (or in response to) a nonconformity. Containment action information can be a description of an action taken to contain, minimize, or otherwise reduce a nonconformity.

Information entered into, included with, and/or stored by an example corrective module and, in particular, a preventive action sub-module may include: action number, action category, status, source, violation, cost, issued-to member, control member, issuer, initiate date, response date, control review, issuer verification, potential nonconformity, root cause, preventive action, and containment action. Similarly-named items includable in both a corrective action sub-module and a preventive action sub-module can have the same description. Potential nonconformity information can be items, products, or other things in the operation of an enterprise that have been identified as possibly nonconforming. Preventive action information can be a description of an action taken to correct (or in response to) a potential nonconformity.

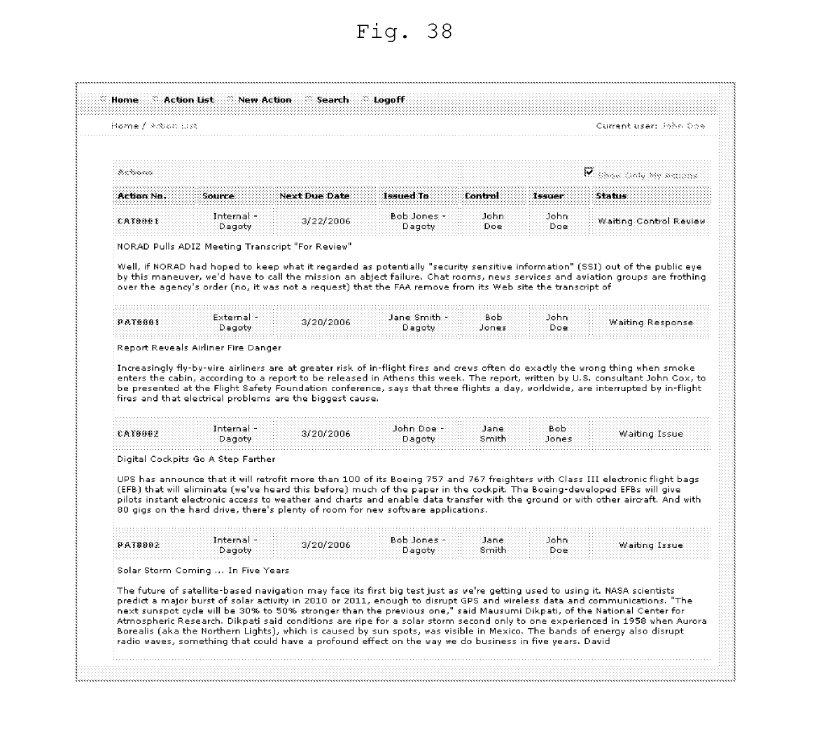

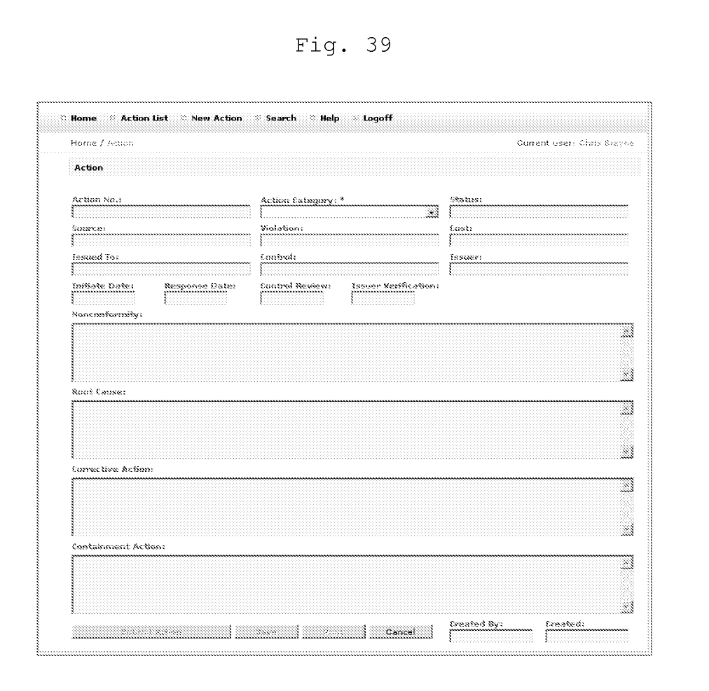

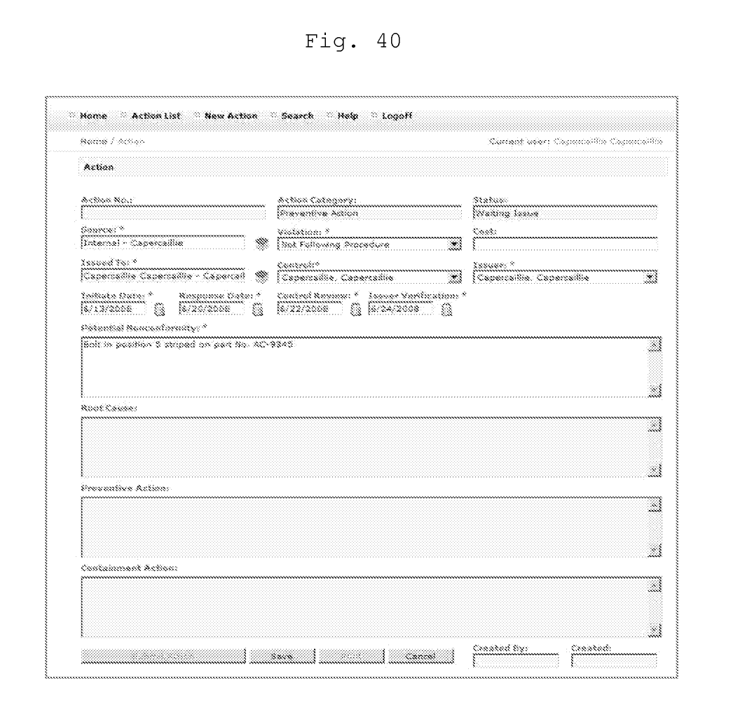

According to an example embodiment of the invention, a corrective module can include routines for: listing corrective and preventive actions; creating and editing corrective actions; creating and editing preventive actions; reviewing actions; exporting actions; and searching preventive and corrective actions. FIG. 38 illustrates a display window of an action listing routine according to an example embodiment of the invention. This action listing routine can be similar in function to the listing routines described above in connection with other modules. Similarly, FIGS. 39 and 40 illustrate display windows of routines for creating corrective and preventive actions, respectively. These routines also can be similar in function to the creation routines described above in connection with other modules.

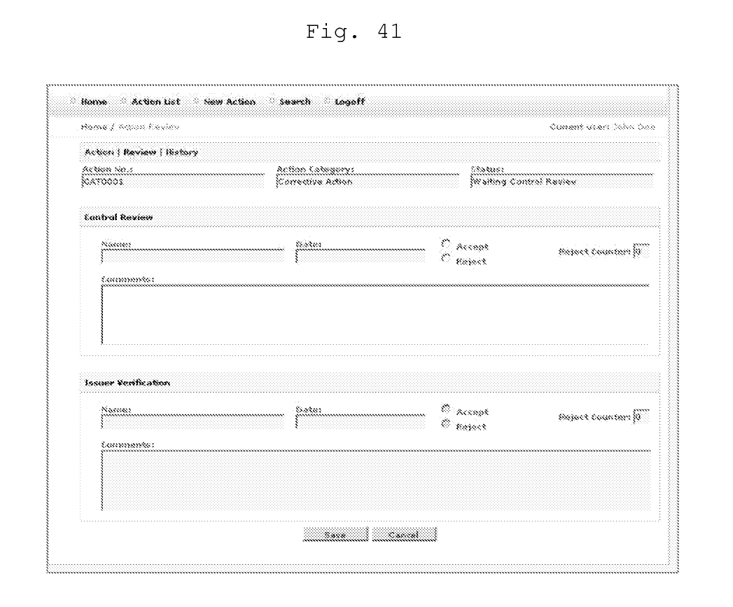

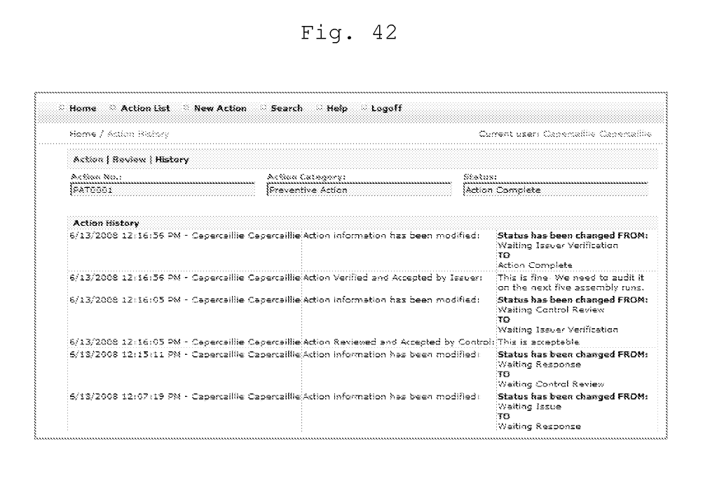

FIG. 41 illustrates a display window of a routine for reviewing corrective and preventive actions. The review of a corrective (or preventive) action can involve review by both a control member and an issuer. A control member can use the review routine to review a response to an action. As described above, in an example embodiment of the invention, the control member reviews an issued-to member's response to ensure that the response is complete, timely, and correct. The control member also can use the routine to enter comments to the response. Once the control member has reviewed and approved the action, an issuer can review the response. According to this example embodiment of the invention, the issuer reviews and verifies that the issued-to member's response to an action properly corrects the nonconformity (or potential nonconformity) and is appropriate to the needs of the enterprise. If the control member and the issuer approve the response, then the action can be deemed complete. To assist review of an action by, for example, an issuer or a control member, a review routine can include an action history sub-routine, a display window of which is illustrated in FIG. 42. From the action history sub-routine, information regarding the response (including status changes and dates) can be provided.

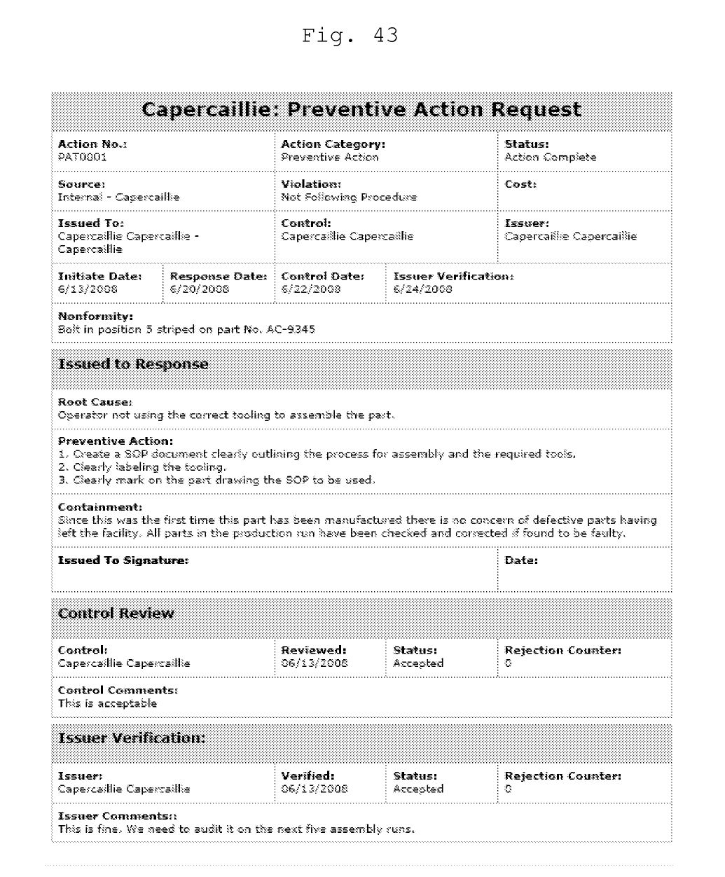

FIG. 43 illustrates a display window of an action exporting routine according to an example embodiment of the invention. The action exporting routine can be used to export information from the corrective module into an external document or file, e.g., a PDF document. In this manner, information from the corrective module can be provided in, for example, printed format. Such a format can be needed if, for example, a signature is required on a corrective action.

By virtue of the example features and routines described above in connection with the corrective module, corrective and preventive actions can be assigned to members (including managers) of an enterprise. Alarms or other reminders can be issued if a corrective or preventive action is overdue, and alarms also can be issued for action status changes, allowing such status changes to be brought to the attention of a member (e.g., a manager). Previous actions can be searched, allowing for review of past actions taken, and an audit trail of all actions can be maintained.

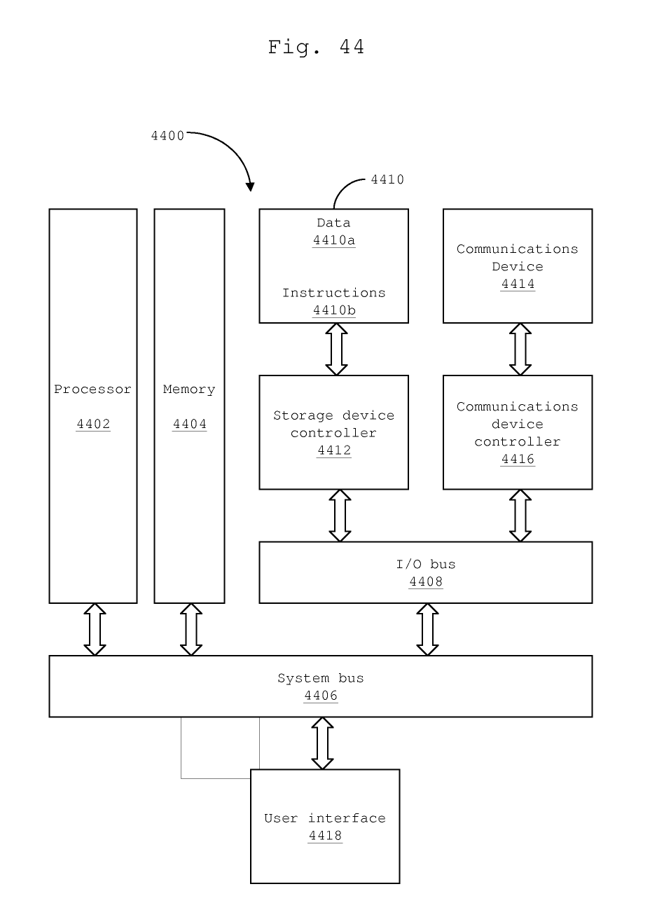

FIG. 44 is a diagram of an example data processing system 4400 which can run, or perform the functions associated with, the suite 100, as well as any of the modules associated therewith. Data processing system 4400 includes a processor 4402 coupled to a memory 4404 via a system bus 4406. The processor 4402 is also coupled to external devices (not shown) via the system bus 4406 and an input/output (I/O) bus 4408, and at least one user interface 4418. The processor 4402 may be further coupled to a communications device 4414 via a communications device controller 4416 coupled to the I/O bus 4408. The processor 4402 uses the communications device 4414 to communicate with a network, and the communications device 4414 may have one or more I/O ports. Processor 4402 also can include an internal clock (not shown in FIG. 44) to keep track of time and periodic time intervals. The user interface 4418 may include, for example, at least one of a keyboard, mouse, trackball, touch screen, keypad, or any other suitable user-operable input device, and at least one of a video display, speaker, printer, or any other suitable output device enabling a user to receive outputted information (such as a BlackBerry or a PDA).

A storage device 4410 having a computer-readable medium is coupled to the processor 4402 via a storage device controller 4412, the I/O bus 4408 and the system bus 4406. The storage device 4410 is used by the processor 4402 and storage device controller 4412 to read and write data 4410a, and to store program instructions 4410b. Alternately, program instructions 4410b can be stored directly in non-volatile or volatile portions of memory 4404. Program instructions 4410b can be used to implement, for example, procedures described in connection with FIGS. 1-43.

The storage device 4410 can also store various routines and operating systems, such as Microsoft Windows, UNIX, and LINUX, or the like, that can be used by the processor 4402 for controlling the operation of system 4400. At least one of the operating systems stored in storage device 4410 can include the TCP/IP protocol stack for implementing a known method for connecting to the Internet or another network, and can also include web browser software for enabling a user of the system 4400 to navigate or otherwise exchange information with the World Wide Web.

In operation, the processor 4402 loads the program instructions 4410b from the storage device 4410 into the memory 4404. The processor 4402 then executes the loaded program instructions 4410b to perform at least part of functionality of the modules, systems, and/or methods described herein. According to an example aspect of the invention, data processing system 4400 (or any component thereof) can be provided as a host-client system. For example, the processor 4402 can execute loaded program instructions 4410b on a host server, which can be located on-site or off-site. Access to the program instructions (and any associated modules, systems, and/or methods) can be provided over a data network (e.g., an intranet or the World Wide Web) to a client terminal (e.g., a personal computer or BlackBerry). In this manner, a centralized system or module need not be maintained to practice the embodiments of the invention.

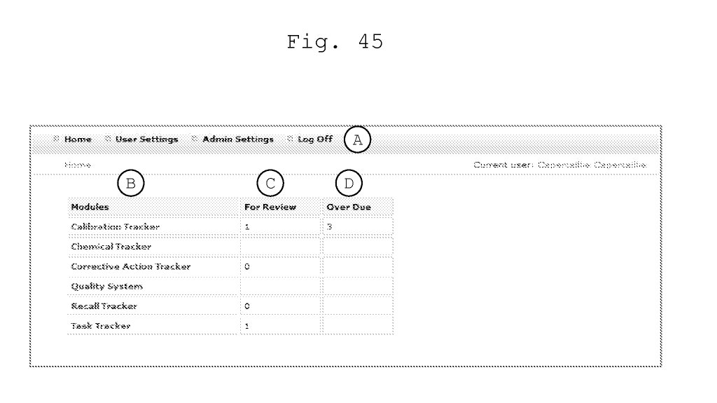

By virtue of the example embodiments described herein, management and control of an enterprise can be effected through the use of modules. These modules are provided to control various aspects of the enterprise, and can be configured in various ways to suit the needs of an enterprise and its managers and members. Management and control of the enterprise also can be effected through the global control of a suite of modules. FIG. 45 illustrates a display window of a global control routine, which may be performed by a system such as, for example, suite 100 of FIG. 1. Global control of modules can include settings and preferences (reference character A) and an overview or display of one or more modules (reference character B), which may include, for example, the statuses, pending items (reference character C), past due items (reference character D), etc., associated with one or more modules. The routine of FIG. 45 can be performed by a network-based system and can be part of a larger, configurable web interface, through which any of the functions, features, routines, etc., of the suite (and modules) described herein can be configured and/or performed.

In the foregoing description, example aspects of the present invention are described with reference to specific example embodiments. Despite these specific embodiments, many additional modifications and variations would be apparent to those skilled in the art. Thus, it is to be understood that example embodiments of the invention may be practiced in a manner otherwise than as specifically described. Accordingly, the specification is to be regarded in an illustrative rather than restrictive fashion. It will be evident that modifications and changes may be made thereto without departing from the broader spirit and scope.

Software embodiments of the example embodiments presented herein may be provided as a computer program product, or software, that may include an article of manufacture on a machine-accessible, machine-readable, or computer-readable medium having instructions. The instructions on the machine-accessible, machine-readable, or computer-readable medium may be used to program a computer system or other electronic device. The machine-readable or computer-readable medium may include, but is not limited to, floppy diskettes, optical disks, CD-ROMs, and magneto-optical disks or other type of media suitable for storing or transmitting electronic instructions. The techniques described herein are not limited to any particular software configuration. They may find applicability in any computing or processing environment. As used herein, the terms “machine-accessible medium,” “machine-readable medium,” or “computer-readable medium” shall include any medium capable of storing, encoding, or transmitting an instruction or sequence of instructions for execution by the machine such that the machine performs any one or more of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Similarly, it should be understood that the figures are presented solely for example purposes. The architecture of the example embodiments presented herein is sufficiently flexible and configurable such that it may be practiced (and navigated) in ways other than that shown in the accompanying figures.

Furthermore, the purpose of the foregoing abstract is to enable the U.S. Patent and Trademark Office, the general public, and scientists, engineers, and practitioners in the art, who are unfamiliar with patent or legal terms or phrases, to quickly determine from a cursory inspection the nature and essence of the technical disclosure of the application. The abstract is not intended to limit the scope of the present invention in any way. It is also to be understood that the processes recited in the claims need not be performed in the order presented.

What is claimed is:

1. A system for managing an enterprise, the system comprising:
a quality policy manual (QPM) module configured to create a quality policy manual for the enterprise, edit the quality policy manual, and store the quality policy manual; and
a quality system procedure (QSP) module configured to create at least one quality system procedure for the enterprise, edit the at least one quality system procedure, and store the at least one quality system procedure,
wherein at least one of the QPM module and the QSP module enable the enterprise to operate with parameters required to obtain and maintain a standardized quality system certification.

2. The system of claim 1, wherein the at least one of the QPM module and the QSP module is further configured to allow a member of the enterprise to select a desired standardized quality system certification from a plurality of standardized quality system certifications.

3. The system of claim 2, wherein the selected standardized quality system certification is one of ISO 9001, AS9100B, AS9110, and AS9120.

4. The system of claim 1, further comprising an operating procedure (OP) module configured to create at least one standard operating procedure for the enterprise, edit the at least one standard operating procedure, and store the at least one standard operating procedure, and
wherein the at least one standard operating procedure is determined by at least one of the quality policy manual and the at least one quality system procedure.

5. The system of claim 4, wherein the QPM module further is configured to archive the quality policy manual prior to storing an edit to the quality policy manual,
wherein the QSP module further is configured to archive the at least one quality system procedure prior to storing an edit to the at least one quality system procedure, and
wherein the OP module further is configured to archive the at least one standard operating procedure prior to storing an edit to the at least one standard operating procedure.

6. The system of claim 5, wherein each of the QPM module and the QSP module further is configured to receive organization information, location information, enterprise classification information, quality system certification information, revision information, and change control information, and
wherein the change control information includes information associated with another module of the system.

7. The system of claim 6, wherein the OP module further is configured to receive information relating to the quality policy manual and information relating to the at least one quality system procedure.

8. The system of claim 4, wherein the QPM module further is configured to output the quality policy manual in a printable formant,
wherein the QSP module further is configured to output the at least one quality system procedure in a printable format, and
wherein the OP module further is configured to output the at least one standard operating procedure in a printable format.

9. The system of claim 8, wherein the quality policy manual includes first content created by a third party, and
wherein the at least one quality system procedure includes second content created by the third party.

10. The system of claim 9, wherein the first content is provided to the enterprise by the QPM module prior to creating the quality policy manual, and
wherein the second content is provided to the enterprise by the QSP module prior to creating the at least one quality system procedure.

11. The system of claim 4, further comprising a task module configured to delegate at least one task to at least one member of the enterprise.

12. The system of claim 11, wherein the at least one task instructs the at least one member to one of create the at least one standard operating procedure, edit the at least one standard operating procedure, and store the at least one standard operating procedure.

13. The system of claim 11, wherein the at least one task is defined by the at least one standard operating procedure.

14. The system of claim 4, further comprising a forms module configured to create at least one form, edit the at least one form, and print the at least one form,
wherein the standardized quality system certification requires the enterprise to provide the at least one form.

15. The system of claim 4, further comprising a skill module configured to track at least one capability of at least one member of the enterprise,
wherein the at least one capability is defined by the at least one standard operating procedure.

16. The system of claim 15, wherein the skill module further is configured to reward the at least one member based upon a skill level at which the at least one member can perform the at least one capability.

17. The system of claim 15, wherein the skill module further is configured to manage at least one job of the enterprise,
wherein the job includes at least one requirement, and
wherein the at least one requirement is determined by one of the quality policy manual, the at least one quality system procedure, and the at least one operating procedure.

18. The system of claim 4, further comprising at least one of:
a calibration module configured to record equipment calibrations;
a corrective action module configured to maintain a quality management system within the enterprise; and
a chemical module configured to track materials used by the enterprise.

19. A method for managing an enterprise, the method comprising:
creating a quality policy manual for the enterprise with a quality policy manual (QPM) module;
storing the quality policy manual with the QPM module;
creating at least one quality system procedure with a quality system procedure (QSP) module;
storing the at least one quality system procedure with the QSP module; and
operating the enterprise within parameters established by at least one of the QPM module and the QSP module, so as to obtain a standardized quality system certification.

20. A computer program product tangibly embodied in a computer-readable medium and having instructions which, when executed by a computer, cause the computer to perform a method for managing an enterprise, the computer program product comprising:
first instructions for creating a quality policy manual for the enterprise with a quality policy manual (QPM) module;
second instructions for storing the quality policy manual with the QPM module;
third instructions for creating at least one quality system procedure with a quality system procedure (QSP) module; and
fourth instructions for storing the at least one quality system procedure with the QSP module.
